(19) United States
(12) Patent Application Publication
(10) Pub. No.: US 2008/0068939 A1
(43) Pub. Date: Mar. 20, 2008

(54) OBJECTIVE LENS ACTUATOR, DIFFRACTIVE OPTICAL ELEMENT, AND OPTICAL PICKUP DEVICE

(76) Inventors: Akihiro Tanaka, Kanagawa (JP); Hiroshi Nakanuma, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/844,033

(22) Filed: Aug. 23, 2007

(30) Foreign Application Priority Data
Sep. 19, 2006 (JP) 2006-253053
Nov. 16, 2006 (JP) 2006-310093
Nov. 24, 2006 (JP) 2006-316732
Dec. 28, 2006 (JP) 2006-353594

(51) Int. Cl. G11B 7/00

(52) U.S. Cl. 369/44.14

(57) ABSTRACT

An objective lens is directly fixed to one surface of a lens holder. Driving coils that generate focusing thrust and tracking thrust are provided in the lens holder, which is elastically supported by supporting springs according to an amount of thrust generated by the driving coils. A compatible diffractive optical element that outputs a laser beam and is compatible with a reflection signal of the laser beam is directly fixed to the lens holder on the rear side of the objective lens. An inertia ballast is provided on the other surface of the lens holder.

### CROSS-REFERENCE TO THE RELATED APPLICATIONS

The present application claims priority to and incorporates by reference the entire contents of Japanese priority documents, 2006-253053 filed in Japan on Sep. 19, 2006, 2006-310093 filed in Japan on Nov. 16, 2006 2006-316732 filed in Japan on Nov. 24, 2006, and 2006-353594 filed in Japan on Dec. 28, 2006.

### BACKGROUND OF THE INVENTION

1. Field of the Invention

The present invention relates to an objective lens actuator, a diffractive optical element, and an optical pickup device.

2. Description of the Related Art

Objective lens actuators have been used in optical pickup devices and the like to apply focusing control and tracking control to objective lenses. For example, Japanese Patent No. 3754225, and Japanese Patent Application Laid-Open Nos. 2005-310315 and 2004-103076 disclose an objective lens actuator that controls positioning of an objective lens at high speed using electric direct modulation of a driving coil.

To control the objective lens to move to the desired position, it is necessary that a movable unit including a lens holder that holds the objective lens is light in weight, a structure of the movable unit is highly rigid not to be internally deformed by high-speed movement or the like, the structure and components of the movable unit are resistible against heat generation involved in power consumption of the driving coil, and the Abbe principle is satisfied as a principle necessary for a structure of a precision drive mechanism.

According to the Abbe principle, to prevent the movable unit from tilting when it is desired to translate the movable unit or prevent a phenomenon against the Abbe principle from occurring, when the drive mechanism has a low-frequency driving characteristic, a driving force needs to act on the center of a support spring that supports the movable unit and, when the drive mechanism has a high-frequency driving characteristic, a driving force needs to act on the inertia center of the movable unit.

In other words, in the case of the objective lens actuator, the thrust center of the driving coil, the elastic center of the support spring that supports the movable unit, and the inertial center of the mass distribution of the movable unit need to coincide with each other.

On the other hand, a high-density and large-capacity objective lens having a high aperture ratio, which is applied to a pickup actuator or the like applicable to a plurality of laser wavelengths, has a relatively large mass.

Therefore, to satisfy the Abbe principle, an inertia ballast mass for adjusting the inertial center of the objective lens is inevitably large.

When a compatible diffractive optical element for a plurality of laser wavelengths is added to the movable unit, the mass of the movable unit increases. Power consumption tends to increase because this increase in the mass of the movable unit deteriorates sensitivity of an inertia region (high-frequency region).

Therefore, the increase in power consumption tends to deteriorate heat resistance of components of the movable unit because a heat generation amount of the driving coil increases. When a component having a relatively large mass is attached to the exterior of the movable unit, it is difficult to secure rigidity of the structure of the movable unit. Moreover, a ratio of the mass distribution falls and a resonance characteristic is deteriorated by internal deformation of the movable unit. As a result, a control characteristic of the mobile unit tends to be deteriorated.

FIGS. 28A to 28C are schematic diagrams of an actuator in which such a compatible diffractive optical element for a plurality of laser wavelengths is added to the movable unit. FIG. 28A is a front view of the objective lens actuator, FIG. 28B is its side view, and FIG. 28C is its bottom view. In FIG. 28A, a vertical direction on the sheet surface is a tangential direction on an optical disk, a direction perpendicular to the sheet surface is a focus direction, and a horizontal direction on the sheet surface is a radial direction (tracking direction). In the following explanation, the vertical and horizontal directions are based on FIG. 28A.

The objective lens actuator includes a stator unit 1 mounted on an optical information recording/reproducing device such as an optical pickup device. The stator unit 1 includes a substantially rectangular base body 2, yokes 2a and 2b provided spaced apart from each other above and below the base body 2, magnets 3a and 3b fixed to surfaces of the yokes 2a and 2b opposed to each other, a movable unit 4 arranged between the magnets 3a and 3b, and a mount 5 fixed to the other surface of the yoke 2a.

The movable unit 4 includes a lens holder 7 that holds an objective lens 6, a driving coil for focusing 8, a driving coil for tracking 9, a plurality of (in this example, four in total) supporting springs 10, one end of which pierces through the mount 5, a printed wiring board 11 for supporting-spring fixing and driving-coil power feeding to which the other ends the supporting springs 10 are fixed by soldering functioning as both mechanical bonding and electrical bonding, and an inertia ballast 12 that is fixed to a rear surface of the lens holder 7 and mainly cancels an inertia primary moment of the objective lens 6. The one end of the supporting springs 10 is connected and fixed to a flexible printed wiring board 13, which is provided in the mount 5, by soldering functioning as both mechanical bonding and electrical bonding.

A diffractive optical element 14 and the objective lens 6 are fixed to the lens holder 7 via a mirror frame 15 as compatible elements for making it possible to record information in and reproduce information from many types of disks.

In the objective lens actuator described above, the objective lens 6 and the diffractive optical element 14 are fixed to the lens holder 7 via the lens holder 7. Therefore, the external shape of the lens holder 7 increases in the radial direction and the tangential direction by the thickness of the mirror frame 15. As a result, the mass of the movable unit 4 tends to increase and the rigidity thereof tends to fall.

Because of a relation of an aperture ratio of the objective lens 6 to the optical disk, the objective lens 6 has to be arranged closer to an upper end of the movable unit 4. Therefore, all of the objective lens 6, the diffractive optical element 14, and the mirror frame 15 are present above the structural center including the thrust center of the driving coil 8 and the center of the supporting springs 10 with respect to the focus direction. As a result, the weight of the inertia ballast 12 that cancels inertia primary moments of the objective lens 6, the diffractive optical element 14, and the mirror frame 15 has to be increased.

When a resin material having heat resistance lower than that of a glass material is used for the diffractive optical element 14 to form the diffractive optical element 14 in a fine structure, reliability against heat generation of the driving coils 8 and 9 tends to be deteriorated. This is because the diffractive optical element 14 is enclosed by the movable unit 4 that is present under a relatively hot environment.

As means for saving video information, sound information, or data on a computer, optical recording media such as a compact disk (CD) having a recording capacity of 0.65 gigabyte (GB) and a digital versatile disk (DVD) having a recording capacity of 4.7 GB are spreading. In recent years, there are stronger demands for further improvement of recording density and a further increase in a capacity.

As means for improving the recording density of such optical recording media, it is effective to increase a numerical aperture (NA) of an objective lens in an optical pickup that writes information in and reads out information from the optical recording media or reduce a wavelength of a light source to thereby reduce a diameter of a beam spot condensed by this objective lens and formed on the optical recording media.

Thus, for example, in “CD optical recording media”, the NA of the objective lens is set to 0.50 and the wavelength of the light source is set to 780 nm. On the other hand, in “DVD optical recording medium” having higher recording density than the “CD optical recording media”, the NA of the objective lens is set to 0.65 and the wavelength of the light source is set to 660 nm. As described above, there are increasing demands for further improvement of recording density and a further increase in a capacity of the optical recording media. For that purpose, it is demanded to increase the NA of the objective lens to be larger than 0.65 or reducing the wavelength of the light source to be shorter than 60 nm.

For such large-capacity optical recording media and optical information processing apparatuses, the standard of “Blue-ray Disc” (BD) that ensures a capacity equivalent to 22 GB using a light source in a blue wavelength region and an objective lens having an NA of 0.85 is proposed.

There is also the standard of “HD-DVD” (HD) that ensures a capacity equivalent to 20 GB using the same light source in the blue wavelength region and an objective lens having an NA of 0.65.

In the former standard, the capacity is increased by reducing the wavelength and increasing the NA compared with those of the DVD optical recording media. In the latter standard, linear recording density can be improved by contriving signal processing instead of not performing the increase in the NA and the capacity is increased by adopting land/groove recording.

The BD and the HD are common in that a blue-violet semiconductor laser light source having an oscillation wavelength of about 405 nm is used. However, the optical recording media have different substrate thicknesses of 0.1 mm and 0.6 mm, respectively.

Even in the optical pickup that can perform any one of recording and reproduction or both of high-density information, it is necessary to ensure any one of recording and reproduction or both of information for CDs and DVDs that have been supplied in a large quantity. It is desirable to select a light source having an appropriate wavelength according to a type of an optical recording medium in which information should be recorded and from which information is reproduced, apply appropriate optical processing to the selected light source, and correct spherical aberration caused by the difference in the substrate thickness of the optical recording media. For example, Japanese Patent Application Laid-Open No. 2006-12393 discloses a technology for correcting the aberration, an aberration correcting element having a diffractive structure is proposed.

However, the aberration correcting element (diffractive optical element) having such a structure has a fine coaxial and concentric diffractive structure on a flat element surface. This diffractive structure is formed on both surfaces of the aberration correcting element (the diffractive optical element). The respective surfaces have different diffractive structures and have aberration correction functions corresponding to different wavelengths of light sources and different standards of optical recording media.

When such a flat diffractive optical element is mounted on the optical pickup or the like, if the front and the rear of the element are inversely attached, appropriate aberration correction functions are not obtained. Moreover, as a shape of the element in the past, the element has an external structure symmetrical in a thickness direction on one surface and the other surface of outer peripheral ends excluding an area of cylindrical aberration correcting element surface. Therefore, it is highly likely that the front and the back of the element are inversely attached to an objective lens holding member.

In the example in the past, it is possible to realize a reduction in weight and an increase in rigidity of the movable unit structure of the actuator mounted with the diffractive optical element and prevention of heat damage to the diffractive optical element. However, accuracy and an angle of attachment of the diffractive optical element are not taken into account. When the objective lens and the diffractive optical element are attached completely coaxially, regular reflection of a plane section of the diffractive optical element changes to return light and generates flare to cause an alias and the like.

Concerning the prevention of the flare, Japanese Patent Application Laid-Open No. 2006-139874 discloses an example of means for preventing this problem. However, there are problems in a function and reliability of a movable unit structure described later.

A measure for preventing flare by obliquely arranging a diffractive optical element is presented. A structure of such an oblique arrangement, i.e., a structure in which the diffractive optical element is arranged to be tilted with respect to an optical axis of an objective lens is proposed. However, the tilt of the diffractive optical element or ensuring of positioning accuracy in a state of the tilt is not taken into account.

Usually, to improve easiness of manufacturing and attachment accuracy of an optical element serving as an axial rotor, a cylindrical or columnar shaft is provided on the exterior of the optical element, a round hole or a stepped round hole is provided in a counterpart member to which the optical element is attached, and positioning of the optical element is performed by fitting the shaft in the round hole.

When a concentric diffractive optical element is used as a compatible element, there are following requirements to satisfy functions of the element. First, it is necessary to highly accurately position an optical axis of an objective lens and an optical axis of the diffractive optical element. Second, because both surfaces of the compatible diffractive optical element have steps and end faces of the steps are planes, integration of the planes of the steps is equivalent to a plane of an entire effective diameter and, to prevent flare due to regular reflection, it is necessary to slightly tilt the plane sections of the steps from the vertical with respect to the optical axis of the lens.

In tilting the plane sections, the center of the diffractive optical element that should be highly accurately positioned with respect to the optical axis of the lens is the substantial center of the surface on the objective lens side. In the case of a diffractive optical element for a compatible optical system that uses a light source having three or more wavelengths to be used in future, compared with the two-wavelength selection or aperture limitation element in the past, extremely highly accurate positioning is required.

To highly accurately position the center of the tilted surface, a hole tilted with respect to a hole in the objective lens 6 needs to be provided in a counterpart member, for example, the lens holder 7, which is a movable hosing, in the lens actuator shown in FIG. 28. However, when such a shape is formed by resin molding, a usual die structure cannot be used. In other words, it is difficult to highly accurately form a shape with respect to a structure required to be reduced in size and weight using a movable mold partially tilted. In other words, components cannot be manufactured or, even if the components can be manufactured, accuracy necessary for assembly cannot be satisfied and assembly work is difficult.

When a member for forming the shape not easily formed is used, it is highly likely that reliability is deteriorated.

In the example of the past described above, the objective lens is provided as a built-in component in the mirror frame exclusively used for the objective lens. However, the use of such a mirror frame exclusively used for the objective lens causes an increase in size of the movable housing and increases a mass of a balance weight for the objective lens, the mirror frame, and the movable housing. The increase in the size and the increase in the mass tend to cause the fall in a high-order resonance frequency. In particular, when a built-in lens component having large overall mass and inertia moment, which uses a mirror frame, is fixed by bonding or the like in an upper part thereof, an influence on deterioration in a high-order resonance characteristic is extremely large because of insufficiency of bonding rigidity.

### SUMMARY OF THE INVENTION

It is an object of the present invention to at least partially solve the problems in the conventional technology.

According to an aspect of the present invention, an objective lens actuator includes a lens holder that holds an objective lens on a first-surface side, a driving coil that is provided in the lens holder and generates focusing thrust and tracking thrust, an elastic supporting member that elastically supports the lens holder according to an amount of thrust generated by the driving coil, a diffractive optical element that is located on an incident side of the objective lens, outputs a laser beam, and is compatible with a reflection signal of the laser beam, and an inertia ballast that is located on a second-surface side of the lens holder. The objective lens and the diffractive optical element are directly fixed to the lens holder.

According to an aspect of the present invention, in a diffractive optical element that supports compatibility among optical recording media of at least three different standards corresponding to light sources of at least three different wavelengths, the diffractive optical element is concentrically diffractive. The diffractive optical element includes a first surface and a second surface each include aberration-correction areas corresponding to the different wavelengths and the different standards, respectively, and a first peripheral area on the first surface and a second peripheral area on the second surface, the first peripheral area and the second peripheral area being externally asymmetrical.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a front view of an objective lens actuator according to a first embodiment of the present invention;

FIG. 1B is a side view of the objective lens actuator shown in FIG. 1A;

FIG. 1C is a bottom view of the objective lens actuator shown in FIG. 1A;

FIG. 2A is a front view of an objective lens actuator according to a second embodiment of the present invention;

FIG. 2B is a side view of the objective lens actuator shown in FIG. 2A;

FIG. 2C is a bottom view of the objective lens actuator shown in FIG. 2A;

FIG. 3A is a front view of an objective lens actuator according to a third embodiment of the present invention;

FIG. 3B is a side view of the objective lens actuator shown in FIG. 3A;

FIG. 3C is a bottom view of the objective lens actuator shown in FIG. 3A;

FIG. 4A is a front view of an objective lens actuator according to a fourth embodiment of the present invention;

FIG. 4B is a side view of the objective lens actuator shown in FIG. 4A;

FIG. 4C is a bottom view of the objective lens actuator shown in FIG. 4A;

FIG. 5 is a schematic diagram of an optical pickup according to a fifth embodiment of the present invention;

FIG. 6 is an enlarged sectional view of an aberration correcting element;

FIG. 7A is a plan view of a first diffractive surface of the aberration correcting element;

FIG. 7B is a plan view of a second diffractive surface of the aberration correcting element;

FIG. 8 is an enlarged sectional view of a section near the aberration correcting element;

FIG. 9A is a schematic diagram of the aberration correcting element in a stepped circular external shape attached to an objective lens holding member;

FIG. 9B is a schematic diagram of the aberration correcting element in a stepped square external shape attached to the objective lens holding member;

FIG. 10A is a schematic diagram of the aberration correcting element in a tapered circular external shape attached to the objective lens holding member;

FIG. 10B is a schematic diagram of the aberration correcting element in a tapered square external shape attached to the objective lens holding member;

FIG. 11A is a schematic diagram for explaining incidence of flare light on a light-receiving element;

FIG. 11B is a schematic diagram for explaining a state in which the flare light avoids the light-receiving element;

FIG. 12A is a schematic diagram of the aberration correcting element in a stepped circular external shape, taking into account flare light, attached to the objective lens holding member;

FIG. 12B is a schematic diagram of the aberration correcting element in a stepped square external shape, taking into account flare light, attached to the objective lens holding member;

FIG. 13A is a schematic diagram of the aberration correcting element in a tapered circular external shape, taking into account flare light, attached to the objective lens holding member;

FIG. 13B is a schematic diagram the aberration correcting element in a tapered square external shape, taking into account flare light, attached to the objective lens holding member;

FIG. 14 is a perspective view of an actuator of the optical pickup;

FIG. 15 is a block diagram of an optical information processing device;

FIG. 16 is a partial sectional view of a lens holder of a lens actuator according to a seventh embodiment of the present invention;

FIG. 17 is a partial sectional view of a lens holder of a lens actuator according to an eighth embodiment of the present invention;

FIG. 18 is a partial sectional view of a lens holder of a lens actuator according to a ninth embodiment of the present invention;

FIG. 19 is a partial sectional view of a lens holder of a lens actuator according to a tenth embodiment of the present invention;

FIG. 20 is a partial sectional view of a lens holder of a lens actuator according to an eleventh embodiment of the present invention;

FIG. 21A is a sectional view of a lens holder of a lens actuator according to a twelfth embodiment of the present invention;

FIG. 21B is a bottom view of an upper housing of the lens actuator shown in FIG. 21A;

FIG. 22 is a partial sectional view of a lens holder of a lens actuator according to a thirteenth embodiment of the present invention;

FIG. 23 is a partial sectional view of a lens holder of a lens actuator according to a fourteenth embodiment of the present invention;

FIG. 24 is a partial sectional view of a lens holder of a lens actuator according to a fifteenth embodiment of the present invention;

FIG. 25 is a partial sectional view of a lens holder of a lens actuator according to a sixteenth embodiment of the present invention;

FIG. 26 is a partial sectional view of a lens holder of a lens actuator according to a seventeenth embodiment of the present invention;

FIG. 27 is a schematic diagram of an optical pickup device mounted with the objective lens actuator according to the embodiments;

FIG. 28A is a front view of a conventional objective lens actuator;

FIG. 28B is a side view of the conventional objective lens actuator; and

FIG. 28C is a bottom view of the conventional objective lens actuator.

### DETAILED DESCRIPTION OF THE PREFERRED EMBODIMENTS

Exemplary embodiments of the present invention are explained in detail below referring to the accompanying drawings. Like reference characters refer to corresponding elements throughout the several views of the drawings.

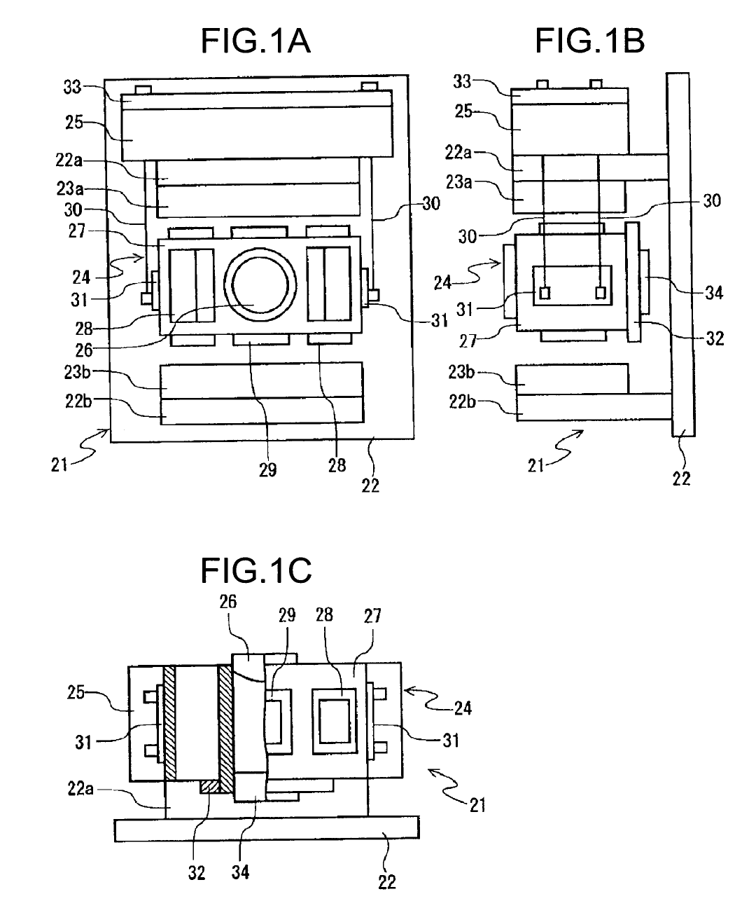

FIG. 1A is a front view of an objective lens actuator according to a first embodiment of the present invention. FIG. 1B is a side view of the objective lens actuator. FIG. 1C is a bottom view of the objective lens actuator. In FIG. 1A, a vertical direction on the sheet surface is a tangential direction on an optical disk, a direction perpendicular to the sheet surface is a focus direction, and a horizontal direction on the sheet surface is a radial direction (tracking direction). In the following explanation, the vertical and horizontal directions are based on FIG. 1A.

The objective lens actuator includes a stator unit 21 mounted on an optical information recording/reproducing device. The stator unit 21 includes a substantially rectangular base body 22, yokes 22a and 22b provided spaced apart from each other above and below the base body 22, magnets 23a and 23b fixed to surfaces of the yokes 22a and 22b opposed to each other, a movable unit 24 arranged between the magnets 23a and 23b, and a mount 25 fixed to the other surface of the yoke 22a.

The movable unit 24 includes a lens holder 27 that holds an objective lens 26, a driving coil for focusing 28, a driving coil for tracking 29, a plurality of (in this example, four in total) supporting springs 30, one end of which pierces through the mount 25, a printed wiring board 31 for supporting-spring fixing and driving-coil power feeding to which the other ends the supporting springs 30 are fixed by soldering functioning as both mechanical bonding and electrical bonding, and an inertia ballast 32 that is fixed to a rear surface of the lens holder 27 and mainly cancels an inertia primary moment of the objective lens 26.

The movable unit 24 is constituted such that the operation center thereof and an optical axis of the objective lens 25 coincide with each other. The one end of the supporting springs 30 is connected and fixed to a flexible printed wiring board (or a pattern formed board) 33, which is provided in the mount 25, by soldering functioning as both mechanical bonding and electrical bonding. A damper material (not shown) for vibration attenuation is embedded in the mount 25 to wrap the supporting springs 30.

The driving coil for focusing 28 and the driving coil for tracking 29 are electrically connected to the printed wiring board 31 for supporting-spring fixing and driving-coil power feeding.

In this embodiment, the supporting springs 30 are wire springs. As a method of fixing the supporting springs 30, the supporting springs 30 are fixed to the printed wiring board 31 for supporting-spring fixing and driving-coil power feeding by soldering functioning as both mechanical bonding and electrical bonding. However, the supporting springs 30 of an arbitrary material and an arbitrary sectional shape can be used. As a method of fixing the supporting springs 30, it is conceivable to use methods such as bonding and insert molding.

The objective lens 26 is directly fixed to an end of the lens holder 27 as a compatible element for making it possible to record information in and reproduce information from many types of disks while being spaced apart from a diffractive optical element 34.

On the other hand, the diffractive optical element 34 is directly fixed to an end of the lens holder 27 on the opposite side of the objective lens 26. The diffractive optical element 34 is made of resin. Therefore, it is possible to highly accurately manufacture a fine pattern at low cost, it is easy to attach the diffractive optical element 34 to the lens holder 27, and it is also possible to perform centering and the like of the diffractive optical element 34.

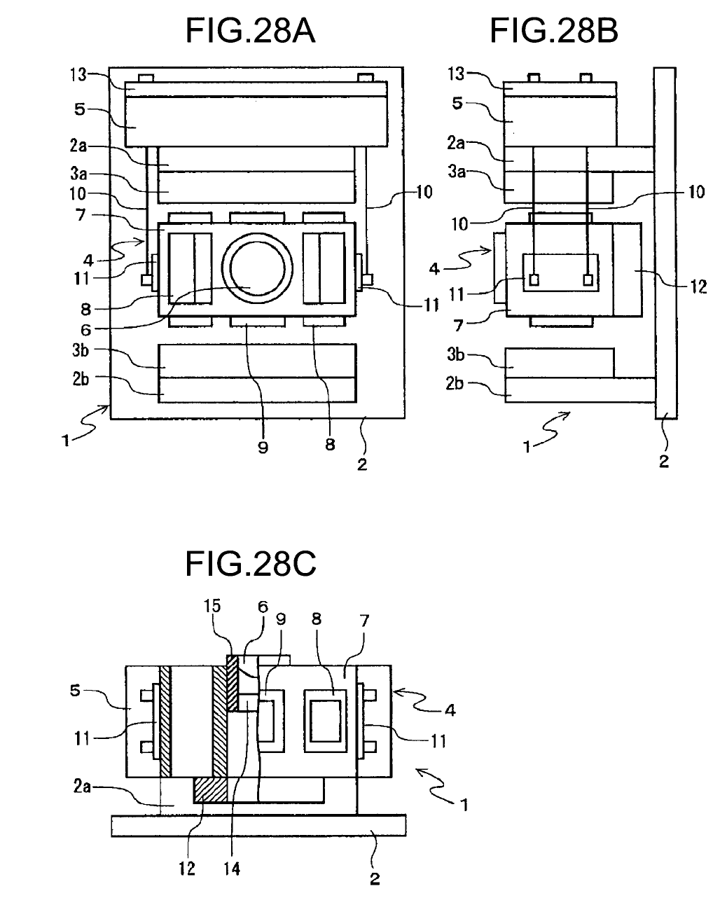

In this structure, it is possible to make the mirror frame 15 (see FIG. 28) in the structure in the past described above unnecessary and reduce the external shape of the movable unit 24 by the thickness of the mirror frame 15. Therefore, it is possible to contribute to a reduction in size and weight of the movable unit 24.

An inertial primary moment of the diffractive optical element 34 has an action of offsetting an inertial primary moment of the objective lens 26. Therefore, it is possible to reduce the weight of the inertia ballast 32 and contribute to a further reduction in weight of the movable unit 24.

Moreover, there is no component arranged to prevent assembly of the objective lens 26 and the diffractive optical element 34 to the lens holder 27. Therefore, it is possible to easily perform assembly of the objective lens 26 and the diffractive optical element 34 to the lens holder 27 at any stage.

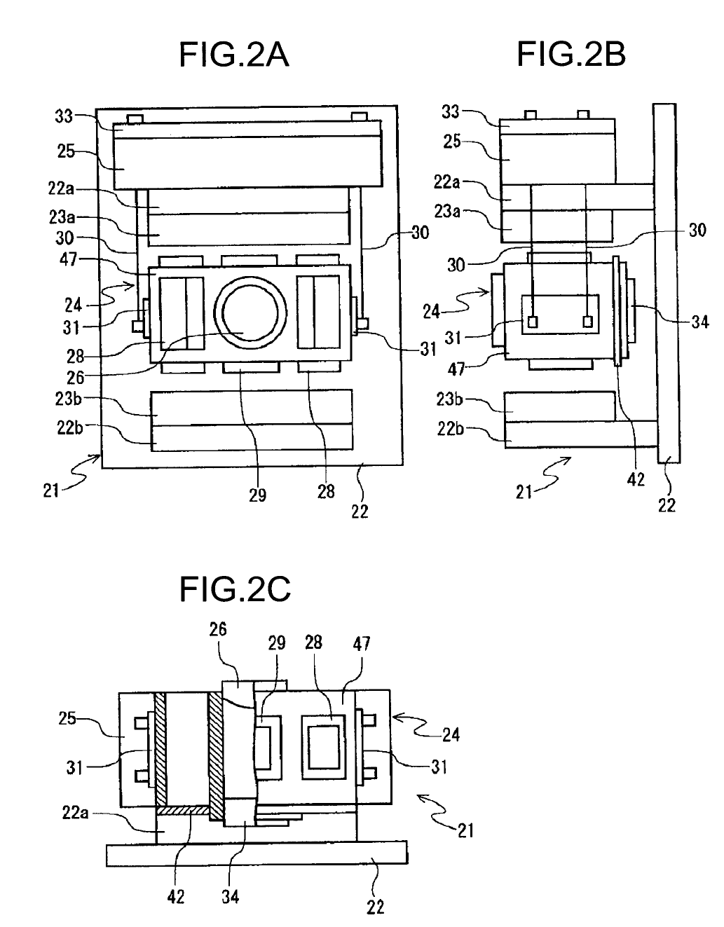

FIG. 2A is a front view of an objective lens actuator according to a second embodiment of the present invention. FIG. 2B is a side view of the objective lens actuator. FIG. 2C is a bottom view of the objective lens actuator. The objective lens actuator according to the second embodiment is basically similar to that of the first embodiment, and the same description is not repeated.

In this second embodiment, an inertia ballast 42 is a metal sheet, which is easily manufactured and inexpensive. The inertia ballast 42 is mounted on substantially the entire surface at a lowest end of a lens holder 47 excluding the diffractive optical element 34. This makes it possible to strengthen a structure including the lens holder 47 and the inertia ballast 42, both of which alone cannot easily secure rigidity for realizing a reduction weight, through mutual reinforcement.

The inertia ballast 42 can be positioned to shield the diffractive optical element 34 from the heat of the driving coils 28 and 29 and can be formed of a material having high density at a fixed distance from the diffractive optical element 34. Therefore, it is possible to expect an effect of a radiator plate by adjusting an area of the inertia ballast 42 and further improve heat resistance against heat generation of the driving coils 28 and 29.

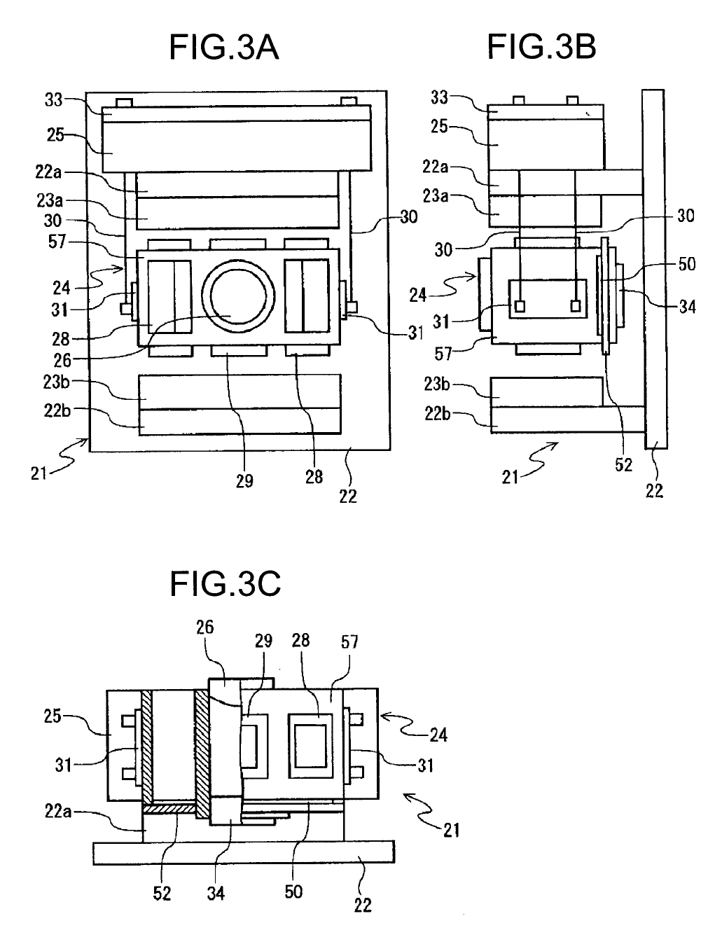

FIG. 3A is a front view of an objective lens actuator according to a third embodiment of the present invention. FIG. 3B is a side view of the objective lens actuator. FIG. 3C is a bottom view of the objective lens actuator. The objective lens actuator according to the third embodiment is basically similar to that of the first embodiment, and the same description is not repeated.

In this third embodiment, an inertia ballast 52 is fixed at four corners in the outer periphery of a lens holder 57 to form a gap 50. Therefore, even if sink or warp occurs during molding or during attachment or sink or warp due to heat generation occurs in the lens holder 57, the inertia ballast 52, and the like, it is possible to compensate for the sink or the warp through the effect of mutual reinforcement of the lens holder 57, the inertia ballast 52, and the like. Because a relative positional relation between the lens holder 57 and the inertia ballast 52 does not change, it is possible to enjoy the merit of heat resistance and heat radiation by the inertia ballast 52 as in the second embodiment.

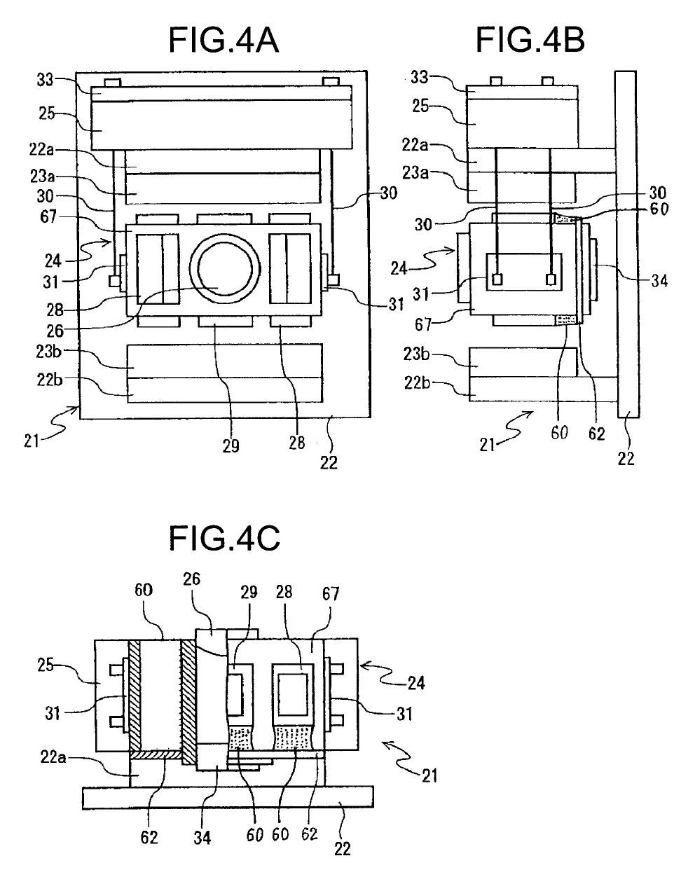

FIG. 4A is a front view of an objective lens actuator according to a fourth embodiment of the present invention. FIG. 4B is a side view of the objective lens actuator. FIG. 4C is a bottom view of the objective lens actuator. The objective lens actuator according to the fourth embodiment is basically similar to that of the first embodiment, and the same description is not repeated.

In this fourth embodiment, as shown in FIGS. 4B and 4C, a silicone material 60 is filled between the driving coils 28 and 29 and an inertia ballast 62 in a lens holder 67. Paths having a low heat resistance are formed from the driving coils 28 and 29, which are heat sources, to the inertia ballast 62 serving as a radiator plate. In this way, heat of the driving coils 28 and 29 is prevented from being transmitted to the diffractive optical element 34.

As described above, it is possible to create the paths having a low heat resistance while minimizing an increase in the mass of the movable unit 4. Therefore, it is possible to permit the heat of the driving coils 28 and 29 to escape to the inertia ballast 62 side rather than the lens holder 27 side, intensify a function of the inertia ballast 62 as the radiator plate, and improve reliability of the optical performance of the objective lens actuator.

The objective lens actuator according to the embodiments of the present invention is a lens actuator that is mounted on a pickup for recording information in and reproducing information from an optical disk and is capable of driving a lens to translate on two axes in the focus direction and the radial direction as described above. Besides, it goes without saying that the present invention is applicable to, for example, an actuator that is capable of driving a lens on three axes or four axes including tilt correction of a radial axis and a tangential axis in addition to this two-axis translation driving and an actuator mounted with at least driving coils for two-axis driving in a movable unit or driving coils for three-axis or four-axis driving in the movable unit.

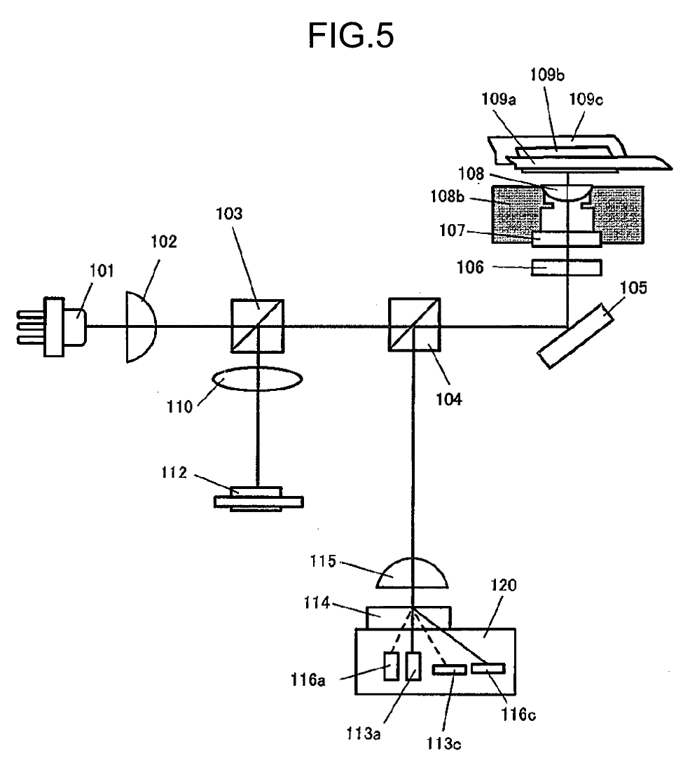

FIG. 5 is a schematic diagram of an optical pickup according to a fifth embodiment of the present invention. The optical pickup is a compatible optical pickup that records information in and reproduces information from, for example, three types of optical recording media (BD, DVD, and CD recording media) at different numerical apertures (NAs) with a single objective lens 108 using different light source wavelengths.

Substrate thicknesses of BD, DVD, and CD optical recording media 109a, 109b, and 109c are 0.1 mm, 0.6 mm, and 1.2 mm, respectively. Numerical apertures (NAs) corresponding to the BD, DVD, and CD optical recording media 109a, 109b, and 109c are 0.85, 0.65, and 0.50, respectively. Wavelengths λ1, λ2, λ3 of first, second, and third light sources are 395 nm to 415 nm, 650 nm to 670 nm, and 770 nm to 805 nm, respectively.

The optical pickup includes, for the BD optical recording medium 109a, a semiconductor laser 101, a collimate lens 102, a polarized beam splitter 103, a wavelength selective beam splitter 104, a deflection prism 105, a quarter-wave plate 106, an aberration correcting element (diffractive optical element) 107, and the objective lens 108, a detection lens 110, and a light-receiving element 112. A center wavelength of the semiconductor laser 101 as a first light source is 405 nm and a numerical aperture (NA) of the objective lens 108 is 0.85. The BD optical recording medium 109a has a substrate thickness of 0.1 mm.

Light emitted by the semiconductor laser 101 is converted into substantially parallel light by the collimate lens 102. The light having passed through the collimate lens 102 is made incident on the polarized beam splitter 103 and deflected by the deflection prism 105. The light is converted into circularly polarized light by the quarter-wave plate 106 and condensed on the BD optical recording medium 109a via the aberration correcting element 107 and the objective lens 108, whereby recording and reproduction of information is performed. After passing through the quarter-wave plate 106, reflected light from the BD optical recording medium 109a is-converted into linear polarized light perpendicular to a polarization direction of the light on a forward path. The light is reflected, separated from incident light, and deflected by the polarized beam splitter 103 and guided onto the light-receiving element 112 by the detection lens 110. Consequently, a reproduction signal, a focus error signal, and a track error signal are detected.

This optical pickup has a two-wavelength laser unit 120 that generates a laser beam for the DVD optical recording medium 109b and a laser beam for the CD optical recording medium 109c. In other words, the optical pickup can emit laser beams having wavelengths different from each other.

Light emitted from a DVD semiconductor laser 113a having the center wavelength of 660 nm to the DVD optical recording medium 109b passes through a collimate lens 115 and the wavelength selective beam splitter 104 and is deflected by the deflection prism 105. The light is then condensed on the DVD optical recording medium 109b through the quarter-wave plate 106, the aberration correcting element 107, and the objective lens 108. A substrate thickness of the DVD optical recording medium 109b is 0.6 mm and a numerical aperture (NA) of the objective lens 108 is 0.65. Switching of the NA is limited by the aberration correcting element 107. After passing through the objective lens 108 and the quarter-wave plate 106, reflected light from the DVD optical recording medium 109b is deflected by the wavelength selective beam splitter 104. The light is separated from incident light and guided onto a DVD light-receiving element 113c by a hologram element 114. Consequently, a reproduction signal, a focus error signal, and a track error signal are detected.

Light emitted from a CD semiconductor laser 116a having the center wavelength of 785 nm to the CD optical recording medium 109c passes through the collimate lens 115 and the wavelength selective beam splitter 104 and is deflected by the deflection prism 105. The light is then condensed on the CD optical recording medium 109c through the quarter-wave plate 106, the aberration correcting element 107, and the objective lens 108. A substrate thickness of the CD optical recording medium 109c is 1.2 mm and a numerical aperture (NA) of the objective lens 108 is 0.50. Switching of the NA is limited by the aberration correcting element 107. After passing through the objective lens 108 and the quarter-wave plate 106, reflected light from the DVD optical recording medium 109b is deflected by the wavelength selective beam splitter 104. The light is separated from incident light and guided onto a CD light-receiving element 116c by the hologram element 114. Consequently, a reproduction signal, a focus error signal, and a track error signal are detected.

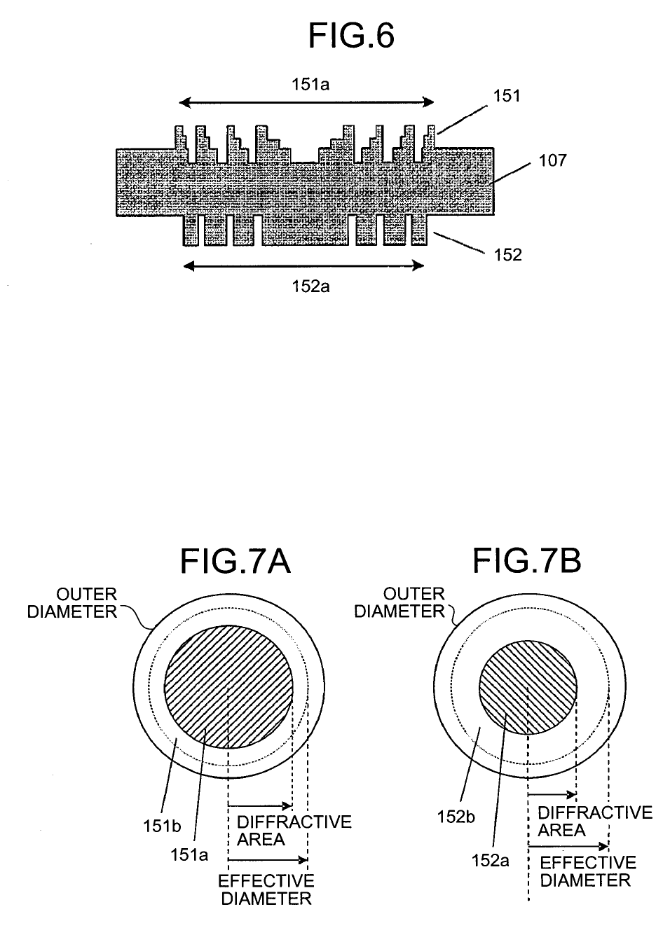

FIG. 6 is an enlarged sectional view of the aberration correcting element 107. FIGS. 7A and 7B are schematic diagrams of diffractive surfaces of the aberration correcting element 107.

The aberration correcting element 107 is a compatible element that has a function of aperture limitation for correcting spherical aberration caused by the light, which is emitted from the DVD semiconductor laser 113a having the center wavelength of 660 nm to the DVD optical recording medium 109b as shown in FIG. 5, in the objective lens 108 because of a difference in a substrate thickness and switching the NA of the objective lens 108. The aberration correcting element 107 also has a function of aperture limitation for correcting spherical aberration caused by the light, which is emitted from the CD semiconductor laser 116a having the center wavelength of 785 nm to the CD optical recording medium 109c, in the objective lens 108 because of a difference in a substrate thickness and switching the NA of the objective lens 108.

A section of a diffractive area of the aberration correcting element 107 includes a plurality of ring-belt concave and convex sections formed in a concentric shape as shown in FIG. 6. The respective ring-belt concave and convex sections are formed in a stepped shape. A pitch of the ring-belt concave and convex sections gradually narrows from an inner side to an outer side of the diffractive area such that this diffractive structure has a lens effect.

As shown in FIGS. 7A and 7B, the aberration correcting element 107 has, in a beam effective diameter, circular center areas (first areas 151a and 152a) in which diffractive grooves are formed and flat sections of peripheral areas (second areas 151b and 152b) of the center areas. The diffractive areas diffract a light beam to correct spherical aberration caused by a difference in a substrate thickness of an information recording medium and a difference in a wavelength. This diffractive structure is formed on both surfaces of the aberration correcting element 107. The aberration correcting element 107 has different aberration correction functions on the respective surfaces. The remaining areas are formed as outer peripheral ends from the effective diameter to the outer diameter.

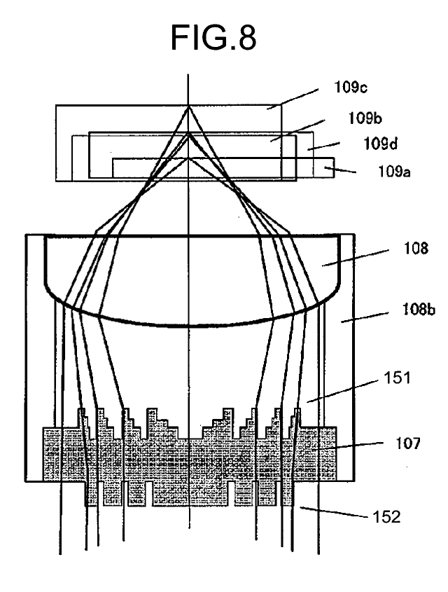

FIG. 8 is a schematic sectional view of the aberration correcting element 107 and the objective lens 108. As shown in FIG. 8, the aberration correcting element 107 and the objective lens 108 are coaxially integrated by an objective lens holding member 108b. Specifically, the aberration correcting element 107 is fixed to one end of the objective lens holding member 108b and the objective lens 108 is fixed to the other end thereof to coaxially integrate the aberration correcting element 107 and the objective lens 108 along an optical axis.

When information is recorded in and reproduced from an optical recording medium, the objective lens 108 moves in a range of about +0.5 mm in a vertical direction with respect to the optical axis according to tracking control. However, because light to the DVD optical recording medium 109b and the CD optical recording medium 109c is diffracted by the aberration correcting element 107, when the aberration correcting element 107 does not move and only the objective lens 108 moves, aberration occurs and a condensing spot is deteriorated. Therefore, the aberration correcting element 107 and the objective lens 108 are integrated and integrally moved during tracking control to obtain a satisfactory condensing spot.

The aberration correcting element 107 only has to be an element formed by providing a UV resin layer on glass, resin, or a glass substrate and providing a diffractive structure in this resin layer. As a material of the aberration correcting element 107, resin is desirable because resin is light in weight, easily molded, and easily produced in a large quantity compared with glass. It is desirable that the aberration correcting element 107 according to the fifth embodiment is light because the aberration correcting element 107 moves for focusing and tracking. Examples of the resin include polymethyl methacrylate (PMMA: refractive indexes at wavelengths of 405 nm, 660 nm, and 785 nm are 1.51, 1.49, and 1.48, respectively) and Zeonex (registered trademark), which is optical resin manufactured by Zeon Corporation, having a high moisture absorption characteristic.

As a method of manufacturing the diffractive structure, when the material is glass, the diffractive structure only has to be manufactured by etching or molding. When the material is resin, the diffractive structure only has to be manufactured by imprint or molding.

As shown in FIGS. 7A and 7B, a surface shape of the aberration correcting element 107 in the vertical direction with respect to the optical axis is a circular shape concentric with the diffractive areas. As described above, the resin such as PMMA used in the fifth embodiment has an advantage that the resin can be injection molded. Therefore, the resin is most widely used for optical components and easily produced in a large quantity. However, on the other hand, moisture absorption is a disadvantage of the resin. This disadvantage not only changes optical characteristics such as a refractive index and a transmittance but also appears as deformation. By forming the aberration correcting element 107 in a circular shape same as that of boundaries between the diffractive areas and the flat areas, a change in the shape due to moisture absorption of PMMA is uniformalized. Therefore, it is possible to reduce waviness and provide a highly accurate optical pickup. The circular shape includes a polygon. The same effect is obtained when the aberration correcting element 107 is formed in a hexagonal shape. The aberration correcting element 107 is formed in the circular shape or the polygonal shape when an external shape thereof has a diameter larger than the light beam effective diameter by 30%. When the external shape is larger, the aberration correcting element 107 may be formed in a square shape.

The compatible optical pickup is explained above as recording information in and reproduces information from, for example, the three types of optical recording media (BD, DVD, and CD recording media) at the different numerical apertures (NAs) with the single objective lens 108 using the different light source wavelengths. However, the compatible optical pickup can record information in and reproduces information from four types of optical recording media (BD, HD, DVD, and CD optical recording media) in different effective pupil radiuses.

The aberration correcting element 107 corrects aberration for four types of optical recording media. The aberration correcting element 107 has an aberration correction function for the DVD and CD optical recording media on one diffractive surface shown in FIG. 6 and has an aberration correction function for the HD optical recording medium on the other diffractive surface.

The aberration correcting element (the diffractive optical element) has a fine coaxial and concentric diffractive structure on a flat element surface same as the element structure described above. This diffractive structure is formed on both surfaces of the aberration correcting element (the diffractive optical element). The respective surfaces have different diffractive structures and have aberration correction functions corresponding to different wavelengths of light sources and different standards of optical recording media. Therefore, it is difficult to visually recognize the difference between structures of the front and the back of the aberration correcting element. However, by forming a shape of the diffractive optical element in this way, it is possible to prevent the front and the rear of the element from being inversely attached and obtain appropriate aberration correction functions.

In the structure according to the fifth embodiment, elements common to the optical pickup and the diffractive optical element (the aberration correcting element) in the past are used except a method of attaching the diffractive optical element to the objective lens holding member. Therefore, in the following explanation of the structure, only elements related to this embodiment are explained.

First, an external shape of the aberration correcting element according to the fifth embodiment is explained in detail. As shown in FIG. 6 and FIGS. 7A and 7B, the diffractive structure formed on the surface of the aberration correcting element 107 has a fine ring-belt shape. It is difficult to visually recognize the difference between structures of the front and the back of the aberration correcting element 107. However, this diffractive structure has different aberration correction functions on the respective surfaces. Therefore, when the aberration correcting element 107 is not attached in a correct direction of the front and the back, an appropriate aberration correction function is not obtained. In the element shape in the past, an external shape of the aberration correcting element 107 is a cylindrical shape and outer peripheral ends thereof are symmetrical with respect to a thickness direction of first and second diffractive surfaces 151 and 152. Therefore, an attachment error tends to occur in that the front and the back is inversely arranged with respect to the objective lens holding member 108b.

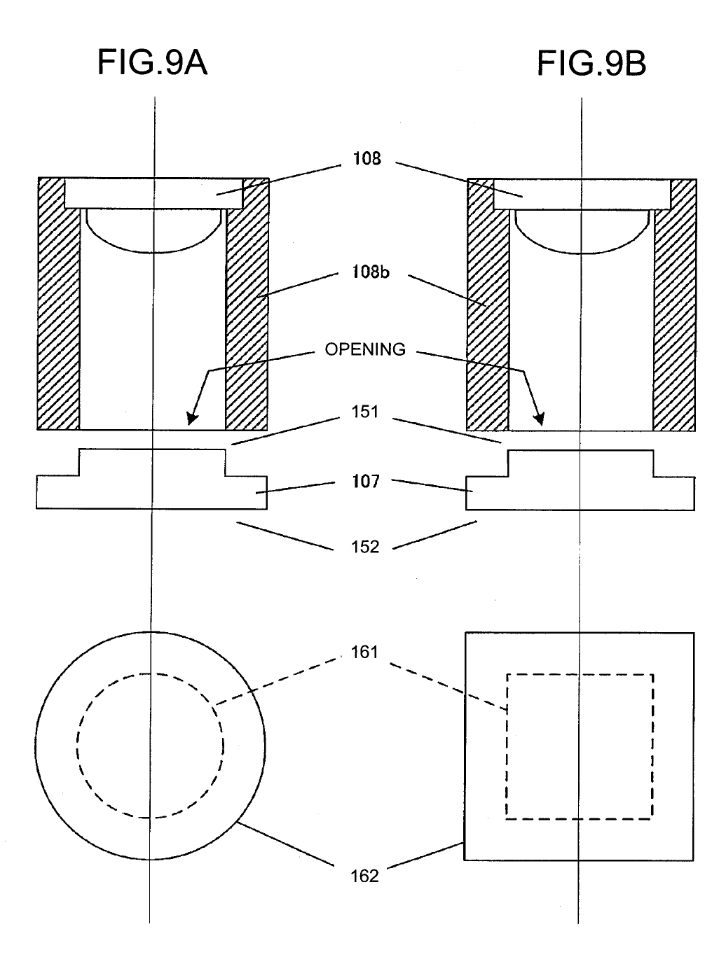

As a first example in the fifth embodiment, as shown in FIG. 9A, an external shape of the aberration correcting element 107 is a shape asymmetrical on the first diffractive surface 151 and the second diffractive surface 152 at outer peripheral ends of the aberration correcting element 107. A diffractive area having an aberration correction function with respect to the optical axis of the objective lens 108 is formed in a concentric circular shape. However, in the outer peripheral ends that are remaining areas of the aberration correcting element 107, a second diffractive-surface outer-diameter 162 is set larger than a first diffractive-surface outer-diameter 161 and an outer peripheral end of the first diffractive surface 151 is formed in a stepped shape that is convex from an outer periphery to an inner periphery thereof.

The first diffractive surface 151 has an outer diameter (the first diffractive-surface outer-diameter 161) equal to or smaller than that of an opening of the objective lens holding member 108b. The second diffractive surface 152 has an outer diameter (the second diffractive-surface outer-diameter 162) larger than that of the opening of the objective lens holding member 108b. Consequently, when the front and the back of the aberration correcting element 107 are inversely attached to the objective lens holding member 108b, the aberration correcting element 107 is not correctly fixed thereto. Therefore, it is possible to prevent the front and the back of the aberration correcting element 107 from being inversely attached. As shown in FIG. 9B, if an area having an aberration correction function can be secured, external shapes of the objective lens holding member 108b and the aberration correcting element may be a square shape.

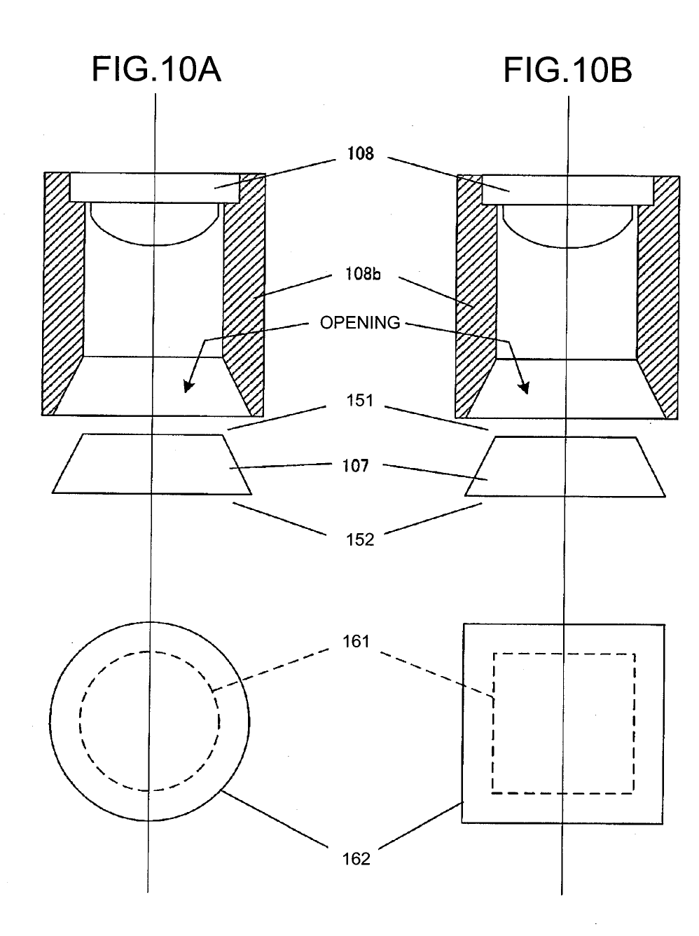

As a second example in the fifth embodiment, as shown in FIGS. 10A and 10B, an external shape of the aberration correcting element 107 is asymmetrical on the first diffractive surface 151 and the second diffractive surface 152. A diffractive area having an aberration correction function with respect to the optical axis of the objective lens 108 is formed in a concentric circular shape. As in the first example, in the outer peripheral end of the aberration correcting element 107, the second diffractive-surface outer-diameter 162 is set larger than the first diffractive-surface outer-diameter 161 and an outer peripheral end of the first diffractive surface 151 is formed in a tapered shape that is convex from an outer periphery to an inner periphery thereof. When an opening of the objective lens holding member 108b is sloped in the same manner, the objective lens holding member 108b is not correctly fixed if the front and the back thereof are inversely attached. Therefore, it is possible to prevent the front and the back from being inversely attached.

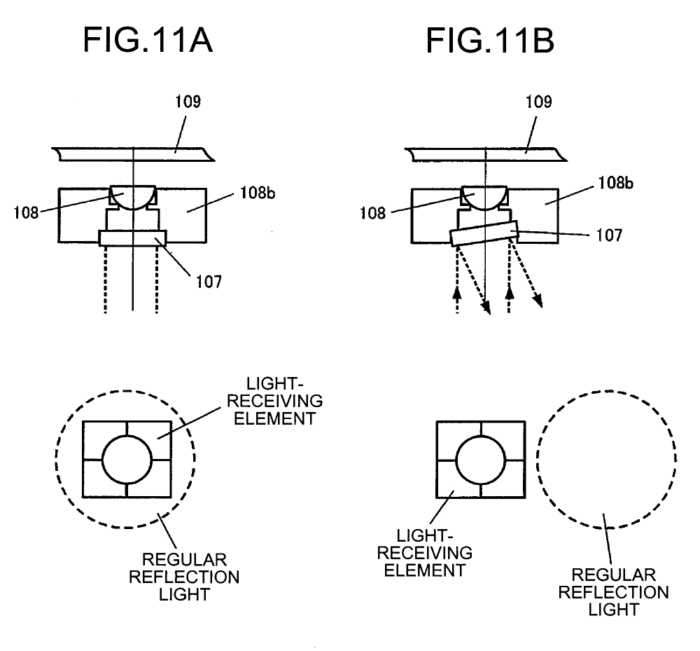

When a flat element such as the aberration correcting element 107 according to the fifth embodiment is used, flare light needs to be taken into account. A part of light traveling from the light source to the objective lens 108 is not transmitted through an incidence surface of an optical component and changes to regular reflection light. When the aberration correcting element 107 is arranged perpendicularly to incident light, the regular reflection light may overlap reflected light from an optical recording medium 109, i.e., signal light, as shown in FIG. 11A and change to noise light. To cope with this problem, there is a method of slightly inclining a plane of incidence on the optical component. The regular reflection light is prevented from being superimposed on the signal light by tilting the aberration correcting element 107 as shown in FIG. 11B.

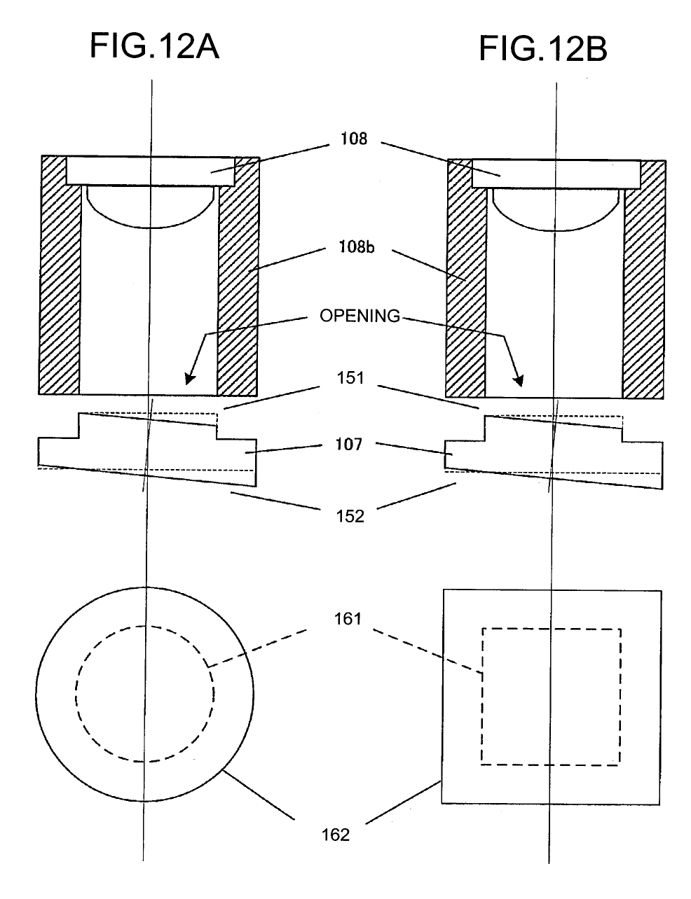

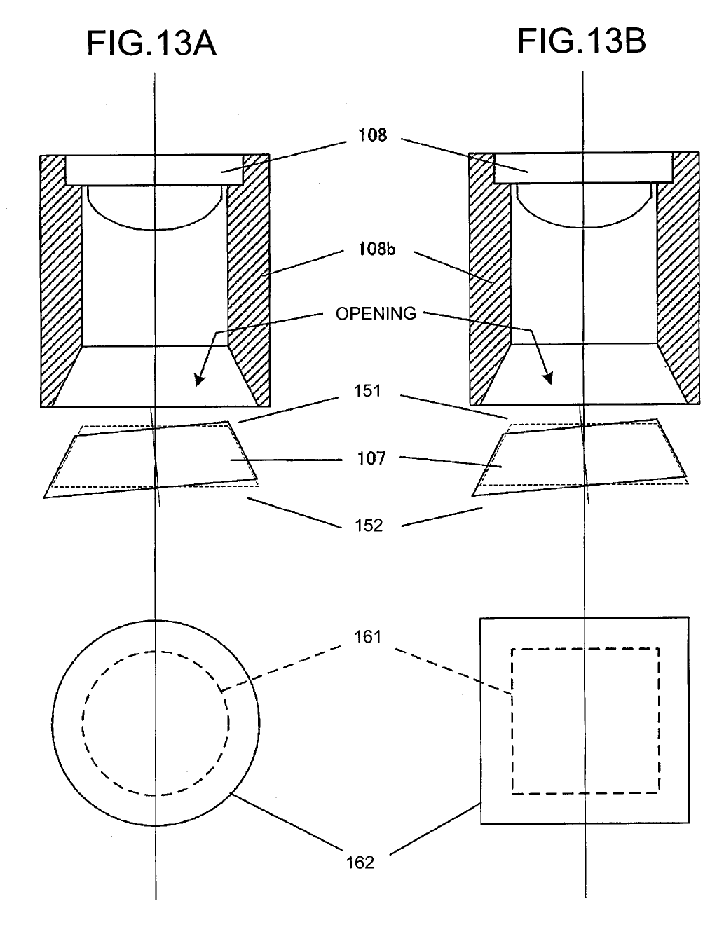

As a third example in the fifth embodiment, as shown in FIGS. 12A and 12B and FIGS. 13A and 13B, an external shape of the aberration correcting element 107 is similar as described for the first and second examples and only a surface on which a diffractive structure is formed is tilted with respect to the optical axis of the objective lens 108. Consequently, when the aberration correcting element 107 is attached to the objective lens holding member 108b without superimposing the regular reflection light on the signal light, it is possible to prevent the front and the back of the aberration correcting element 107 from being inversely attached.

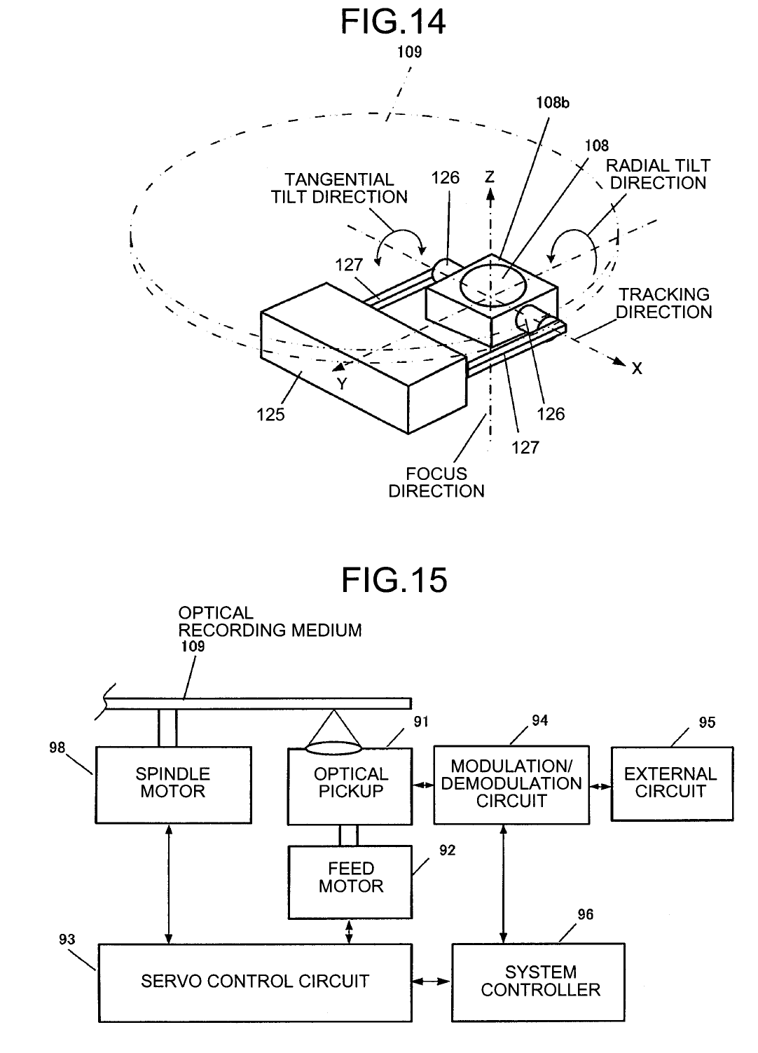

An actuator and an optical information processing device including the diffractive optical element (the aberration correcting element) according to the fifth embodiment are explained below as a sixth embodiment of the present invention. A schematic structure of an actuator of an optical pickup is shown in FIG. 14. The actuator of the optical pickup includes the objective lens 108 and the objective lens holding member 108b that holds the objective lens 108. The actuator of the optical pickup also includes a base unit 125 that supports the objective lens holding member 108b and elastic supporting mechanisms 126 and 127 interposed between the base unit 125 and the objective lens holding member 108b. The elastic supporting mechanisms 126 and 127 elastically support the objective lens holding member 108b with respect to the base unit 125 to allow the objective lens holding member 108b to move in two directions, i.e., the focus direction and the tracking direction. The focus direction refers to a Z axis direction (optical axis direction of the objective lens 108) in FIG. 14 and the tracking direction refers to an X axis direction (radial direction of the optical recording medium 109) in FIG. 14.

The actuator of the optical pickup includes a driving unit (not shown). This driving unit includes a voice coil motor including a permanent magnet provided in the objective lens holding member 108b and a driving coil fixed relatively to the base unit 125. The driving unit drives the objective lens holding member 108b in the two directions according to an input current to the driving coil. The input current to the driving coil of the driving unit is controlled to perform focus servo and tracking servo for causing a predetermined laser beam spot to follow a recording track on an information recording surface of the optical recording medium 109.

FIG. 15 is a block diagram of the optical information processing device. The optical information processing device performs at least one of reproduction, recording, and erasing of information with respect to an optical recording medium using the optical pickup having the diffractive optical element according to the fifth embodiment.

The optical information processing device includes an optical pickup 91 equivalent to the optical pickup described above. The optical information processing device further includes a spindle motor 98 that drives to rotate the optical recording medium 109, the optical pickup 91 used in performing recording and reproduction of an information signal, a feed motor 92 for moving the optical pickup 91 to inner and outer peripheries of the optical recording medium 109, a modulation/demodulation circuit 94 that performs predetermined modulation and demodulation processing, a servo control circuit 93 that performs servo control and the like of the optical pickup 91, and a system controller 96 that performs control of the entire optical information processing device.

The spindle motor 98 is controlled to be driven to rotate at a predetermined number of revolutions by the servo control circuit 93. The optical recording medium 109 as an object of recording and reproduction is chucked on a driving shaft of the spindle motor 98 and controlled to be driven by the servo control circuit 93. The optical recording medium 109 is driven to rotate at the predetermined number of revolutions by the spindle motor 98.

When an information signal is recorded in and reproduced from the optical recording medium 109, as described above, the optical pickup 91 irradiates a laser beam on the optical recording medium 109 driven to rotate and detects return light of the laser beam. The optical pickup 91 is connected to the modulation/demodulation circuit 94. When the information signal is recorded, a signal input from an external circuit 95 and subjected to predetermined modulation processing by the modulation/demodulation circuit 94 is supplied to the optical pickup 91. The optical pickup 91 irradiates, based on the signal supplied from the modulation/demodulation circuit 94, a laser beam subjected to light intensity modulation on the optical recording medium 109. When the information signal is reproduced, the optical pickup 91 irradiates a laser beam of fixed power on the optical recording medium 109 driven to rotate. A reproduction signal is generated from return light of the laser beam and supplied to the modulation/demodulation circuit 94.

The optical pickup 91 is also connected to the servo control circuit 93. When the information signal is recorded and reproduced, as described above, a focus servo signal and a tracking servo signal are generated from the return light that is reflected by the optical recording medium 109 driven to rotate and returns to the optical pickup 91. The servo signals are supplied to the servo control circuit 93.

The modulation/demodulation circuit 94 is connected to the system controller 96 and the external circuit 95. When the information signal is recorded in the optical recording medium 109, the modulation/demodulation circuit 94 receives a signal, which is to be recorded in the optical recording medium 109, from the external circuit 95 and applies predetermined modulation processing to this signal under the control by the system controller 96.

The signal modulated by the modulation/demodulation circuit 94 is supplied to the optical pickup 91. When the information signal is reproduced from the optical recording medium 109, the modulation/demodulation circuit 94 receives a reproduction signal, which is reproduced from the optical recording medium 109, from the optical pickup 91 and applies predetermined demodulation processing to the reproduction signal under the control by the system controller 96. The signal modulated by the modulation/demodulation circuit 94 is output from the modulation/demodulation circuit 94 to the external circuit 95.

The feed motor 92 is a motor for moving the optical pickup 91 to a predetermined position in the radial direction of the optical recording medium 109 when recording and reproduction of the information signal is performed. The feed motor 92 is driven based on a control signal from the servo control circuit 93. The feed motor 92 is connected to the servo control circuit 93 and controlled by the servo control circuit 93.

The servo control circuit 93 controls, under the control by the system controller 96, the feed motor 92 to move the optical pickup 91 to a predetermined position opposed to the optical recording medium 109. The servo control circuit 93 is also connected to the spindle motor 98 and controls operations of the spindle motor 98 under the control by the system controller 96. When the information signal is recorded in and reproduced from the optical recording medium 109, the servo control circuit 93 controls the spindle motor 98 to drive to rotate the optical recording medium 109 at the predetermined number of revolutions.

The tracking servo signal and the focus servo signal may be used as a method of discriminating a type of the optical recording medium 109. By providing the optical pickup according to the embodiments of the present invention in an optical information processing device that records information in and reproduces information from a plurality of types of optical recording media, it is possible to improve accuracy of recording information in and reproducing information from the optical recoding media 109 having different substrate thicknesses.

As described above, according to the sixth embodiment, when the aberration correcting element (the diffractive optical element) 107 is attached to the objective lens holding member 108b used for the objective lens actuator, the optical pickup, and the optical information processing device, it is possible to prevent the front and the back of the aberration correcting element 107 from being inversely attached to form, with a single objective lens, a satisfactory spot on surfaces of a plurality of types of optical recording media (e.g., BD, HD, DVD, and CD optical recording media) having different substrate thicknesses. It is also possible to obtain an appropriate aberration correction function for applying optimum processing of recording, reproduction, and erasing of an information signal to the optical recording media.

In the diffractive optical element and the objective lens actuator, the optical pickup, and the optical information processing device including the diffractive optical element according to the embodiments of the present invention, the external shape of the diffractive optical element is formed to make it impossible to inversely arrange the front and the back of the diffractive optical element. In a manufacturing process of the diffractive optical element, it is possible to prevent the front and the back of the diffractive optical element from being inversely attached to the objective lens and obtain an appropriate aberration correction function. The diffractive optical element and the objective lens actuator, the optical pickup, and the optical information processing device are useful as compatible devices that handle three or more types of optical recording media having different recording densities.

FIG. 16 is a partial sectional view of the lens holder of the lens actuator for an optical pickup according to a seventh embodiment of the present invention. In a lens holder 201 as a housing, an objective lens 202 is provided in an upper part thereof and a diffractive optical element 203 is provided in a lower part thereof.

The objective lens 202 condenses a light beam on an optical disk (not shown), which is an optical information recording medium, to form a beam spot. The diffractive optical element 203 functions to make optical disks of three or more types of disk standards, which correspond to light beams of at least three wavelengths, compatible (described in detail later).

In the seventh embodiment, it is possible to provide an actuator having a small and light movable unit by setting an optical axis of the diffractive optical element 203 to be tilted with respect to an optical axis of the objective lens 202 and providing, positioning, and fixing the objective lens 202 and the diffractive optical element 203 in the single lens holder 201. Moreover, it is possible to prevent optical disturbance due to regular reflection by attaching the diffractive optical element 203 to be tilted with respect to the optical axis of the objective lens 202.

In this embodiment, three points or three small areas having a necessary tilt are provided on contact sides on a lower side of the lens holder 201 and an upper side of a flange section 203a. Specifically, as shown in FIG. 16, three types of projections 213 are protrudingly provided on the lower side of the lens holder 201, and the projections 213 are set in contact with a flat side on the upper side of the flange section 203a. The projection 213 on the front side is not shown in FIG. 16.

The projections 213 and the flat surfaces corresponding to the projections 213 are not limited to the structure described above. It is sufficient that the projections 213 are provided in one of the lens holder 201 and the diffractive optical element 203 and the flat surfaces are formed in the other.

In this embodiment, it is necessary to separately perform alignment of optical axes. However, it is possible to adjust alignment of an optical axis in the center of an optical surface on the objective lens side in the diffractive optical element 203 to the optical axis of the objective lens 202, for example, referring to an optical transmitted beam characteristic.

After the adjustment, the lens holder 201 and the flange section 203a are bonded using a publicly-known bonding method such as an ultraviolet curing adhesive.

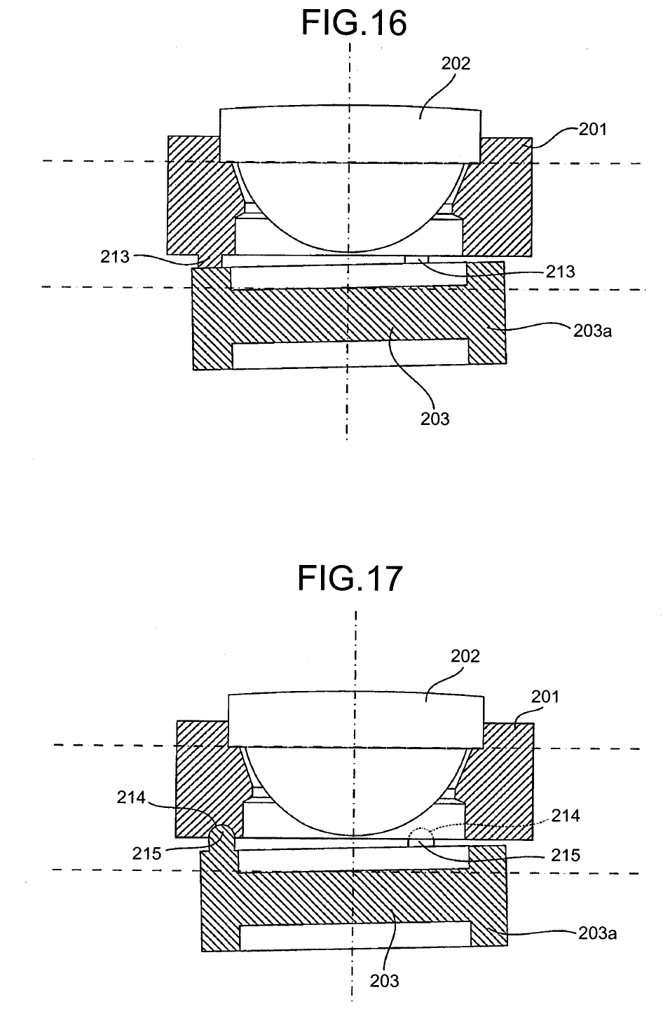

FIG. 17 is a partial sectional view of the lens holder of the lens actuator according to an eighth embodiment of the present invention.

In the eighth embodiment, hemispherical recesses 214 are provided at three positions and arranged at equal angles of 120 degrees around the optical axis of the objective lens 202 in the lens holder 201. Three hemispherical projections 215 are provided in the flange section 203a in association with the recesses 214. The recesses 214 and the projections 215 are brought into contact with each other to set relative positions and tilts thereof. The recess 214 and the projection 215 on the front side are not shown in FIG. 17.

In the eighth embodiment, the three projections 215 of the flange section 203a are set at the same height with respect to a reference surface of the diffractive optical element 203. The positions and the depth of the recesses 214 on the lens holder 201 side are adjusted to the positions of the projections 215 at the time when the reference surface is tilted. Consequently, it is possible to accurately perform positioning and adjustment of a tilt of the diffractive optical element 203 with respect to the objective lens 202 without providing a structure tilted with respect to the optical axis of the objective lens 202.

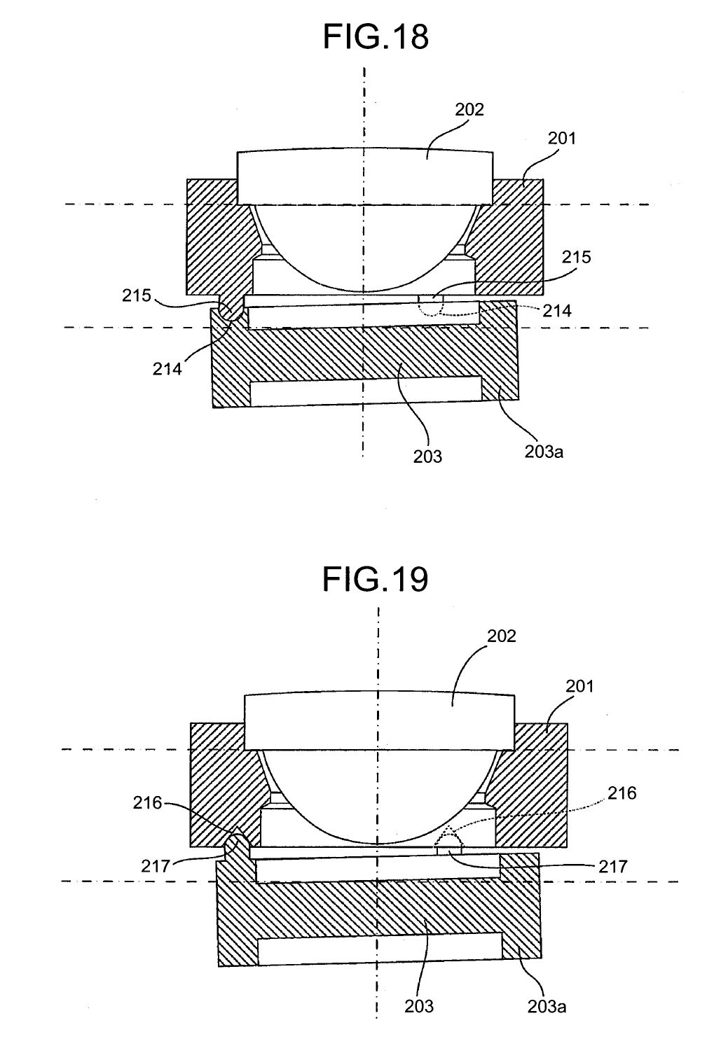

FIG. 18 is a partial sectional view of the lens holder of the lens actuator according to a ninth embodiment of the present invention. The ninth embodiment is different from the eighth embodiment in that positions where the recesses 214 and the projections 215 are set are opposite. In the ninth embodiment, the hemispherical projections 215 are provided at three positions and arranged at equal angles of 120 degrees around the optical axis of the objective lens 202 in the lens holder 201. The three hemispherical recesses 214 are provided in the flange section 203a in association with the projections 215. The recesses 214 and the projections 215 are brought into contact with each other to set relative positions and tilts thereof.

In the ninth embodiment, the three recesses 214 of the flange section 203a are set at the same depth with respect to the reference surface of the diffractive optical element 203. The positions and the height of the projections 215 on the lens holder 201 side are adjusted to the positions of the recesses 214 at the time when the reference surface is tilted. Consequently, it is possible to accurately perform positioning and adjustment of a tilt of the diffractive optical element 203 with respect to the objective lens 202 without providing a structure tilted with respect to the optical axis of the objective lens 202.

FIG. 19 is a partial sectional view of the lens holder of the lens actuator according to a tenth embodiment of the present invention. In the tenth embodiment, conical recesses 216 are provided at three positions and arranged at equal angles of 120 degrees around the optical axis of the objective lens 202 in the lens holder 201. Three hemispherical projections 217 are provided in the flange section 203a in association with the recesses 216. The recesses 216 and the projections 217 are brought into contact with each other to set relative positions and tilts thereof. The recess 216 and the projection 217 on the front side are not shown in FIG. 19.

In the tenth embodiment, the three projections 217 of the flange section 203a are set at the same height with respect to the reference surface of the diffractive optical element 203. The positions and the depth of the recesses 216 on the lens holder 201 side are adjusted to the positions of the projections 217 at the time when the reference surface is tilted. Consequently, it is possible to accurately perform positioning and adjustment of a tilt of the diffractive optical element 203 with respect to the objective lens 202 without providing a structure tilted with respect to the optical axis of the objective lens 202.

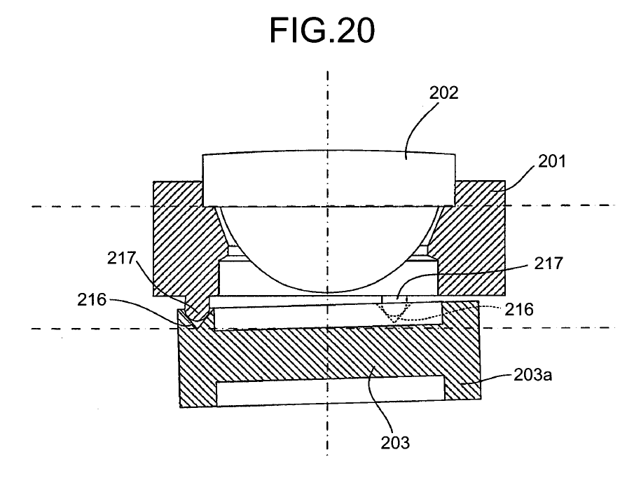

FIG. 20 is a partial sectional view of a lens holder of a lens actuator according to an eleventh embodiment of the present invention. The eleventh embodiment is different from the tenth embodiment in that positions where the recesses 216 and the projections 217 are set are opposite. In the eleventh embodiment, the hemispherical projections 217 are provided at three positions and arranged at equal angles of 120 degrees around the optical axis of the objective lens 202 in the lens holder 201. The three conical recesses 216 are provided in the flange section 203a in association with the projections 217. The recesses 216 and the projections 217 are brought into contact with each other to set relative positions and tilts thereof.

In the eleventh embodiment, the three recesses 216 of the flange section 203a are set at the same depth with respect to the reference surface of the diffractive optical element 203. The positions and the height of the projections 217 on the lens holder 201 side are adjusted to the positions of the recesses 216 at the time when the reference surface is tilted. Consequently, it is possible to accurately perform positioning and adjustment of a tilt of the diffractive optical element 203 with respect to the objective lens 202 without providing a structure tilted with respect to the optical axis of the objective lens 202.

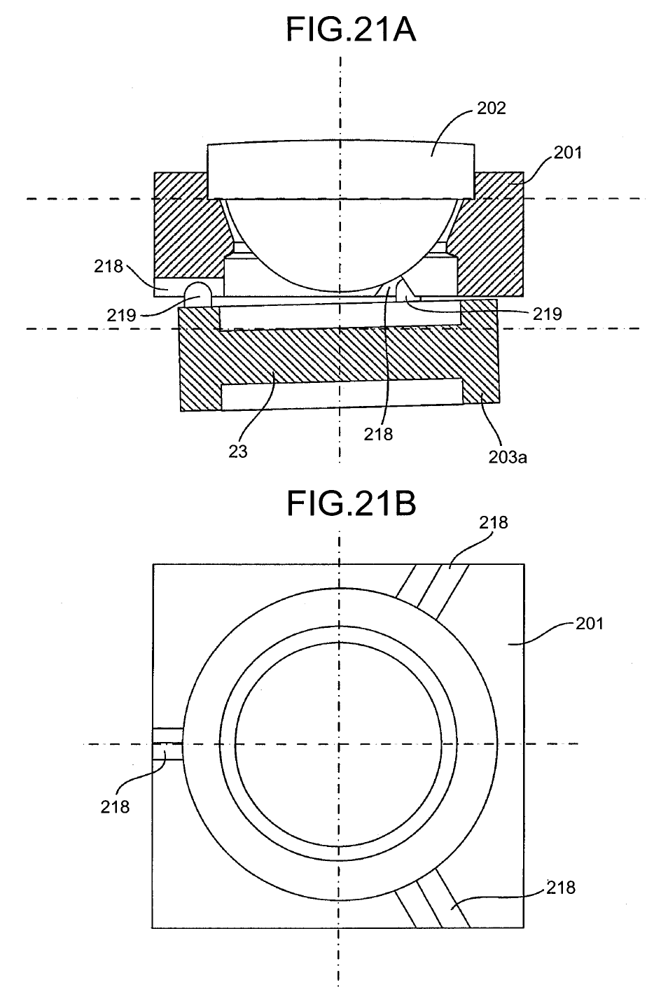

FIG. 21A is a sectional view of a lens holder of a lens actuator according to a twelfth embodiment of the present invention. FIG. 21B is its bottom view. In the twelfth embodiment, V-shaped recesses 218 having symmetrical axes that cross on the optical axis of the objective lens 202 are provided at three positions and arranged at equal angles of 120 degrees around the optical axis of the objective lens 202 in the lens holder 201. The three hemispherical projections 219 are provided in a lower housing 212 of the diffractive optical element 203 in association with the recesses 218. The recesses 218 and the projections 219 are brought into contact with each other to set relative positions and tilts thereof.

In the twelfth embodiment, the three projections 219 of the flange section 203a are set at the same height with respect to the reference surface of the diffractive optical element 203. The positions and the height of the recesses 218 on the lens holder 201 side are adjusted to the positions of the projections 219 at the time when the reference surface is tilted. Consequently, it is possible to accurately perform positioning and adjustment of a tilt of the diffractive optical element 203 with respect to the objective lens 202 without providing a structure tilted with respect to the optical axis of the objective lens 202.

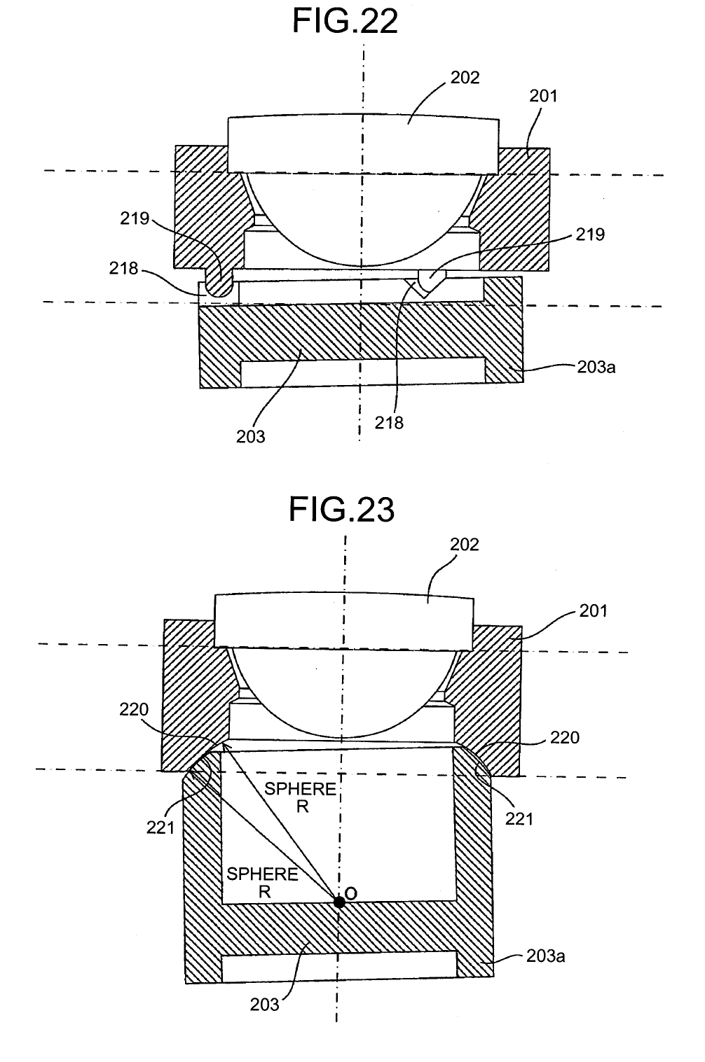

FIG. 22 is a partial sectional view of a lens holder of a lens actuator according to a thirteenth embodiment of the present invention. The thirteenth embodiment is different from the twelfth embodiment in that positions where the recesses 218 and the projections 219 are set are opposite. In the thirteenth embodiment, the V-shaped recesses 218 are provided at three positions and arranged at equal angles of 120 degrees around the optical axis of the objective lens 202 in the lens holder 201. Three hemispherical projections 219 are provided in the lower housing 212 of the diffractive optical element 203 in association with the recesses 218. The recesses 218 and the projections 219 are brought into contact with each other to set relative positions and tilts thereof.

In the thirteenth embodiment, the three recesses 218 of the flange section 203a are set at the same depth with respect to the reference surface of the diffractive optical element 203. The positions and the height of the projections 219 on the lens holder 201 side are adjusted to the positions of the recesses 218 at the time when the reference surface is tilted. Consequently, it is possible to accurately perform positioning and adjustment of a tilt of the diffractive optical element 203 with respect to the objective lens 202 without providing a structure tilted with respect to the optical axis of the objective lens 202.

FIG. 23 is a partial sectional view of a lens holder of a lens actuator according to a fourteenth embodiment of the present invention. In the fourteenth embodiment, a lower end of the lens holder 201 and an upper end of the flange section 203a are brought into contact with each other. Recesses 220 having a shape (with a radius of a sphere R) forming a part of a sphere, which has the center near the center O on the surface on the objective lens 202 side on the optical axis of the diffractive optical element 203, are provided at contact ends of the lens holder 201 and the flange section 203a. Projections 221 having a shape also forming a part of the sphere, which has the center near the center O on the surface, are provided at contact ends with the lens holder 201 in the flange section 203a in association with the recesses 220. The recesses 220 and the projections 221 are brought into contact with each other to set relative positions thereof.

Although a tilt regulating mechanism is not shown in FIG. 23, the lens holder 201 and the flange section 203a can be fixed after adjustment. Alternatively, projections can be provided in the tilted flange section 203a and brought into contact with the lens holder 201 to determine a tilt of the flange section 203a and fix the flange section 203a. Consequently, it is possible to accurately perform positioning and adjustment of a tilt of the diffractive optical element 203 with respect to the objective lens 202 without providing a structure tilted with respect to the optical axis of the objective lens 202.

FIG. 24 is a partial sectional view of a lens holder of a lens actuator according to a fifteenth embodiment of the present invention. The fifteenth embodiment is the same as the fourteenth embodiment in that the lower end of the lens holder 201 and the upper end of the flange section 203a are brought into contact with each other. The projections 221 having a shape (with a radius of a sphere R) forming a part of a sphere, which has the center in the center O near the center of the surface on the objective lens 202 side on the optical axis of the diffractive optical element 203, are provided at contact ends with the lens holder 201 in the flange section 203a. Contact ends with the flange section 203a in the lens holder 201 are set as surfaces 222 formed in a conical shape in association with the projections 221. The projections 221 and the surfaces 222 are brought into contact with each other to set relative positions thereof.

Although a tilt regulating mechanism is not shown in FIG. 24, the lens holder 201 and the flange section 203a can be fixed after adjustment. Alternatively, projections can be provided in the tilted flange section 203a and brought into contact with the lens holder 201 to determine a tilt of the flange section 203a and fix the flange section 203a. Consequently, it is possible to accurately perform positioning and adjustment of a tilt of the diffractive optical element 203 with respect to the objective lens 202 without providing a structure tilted with respect to the optical axis of the objective lens 202.

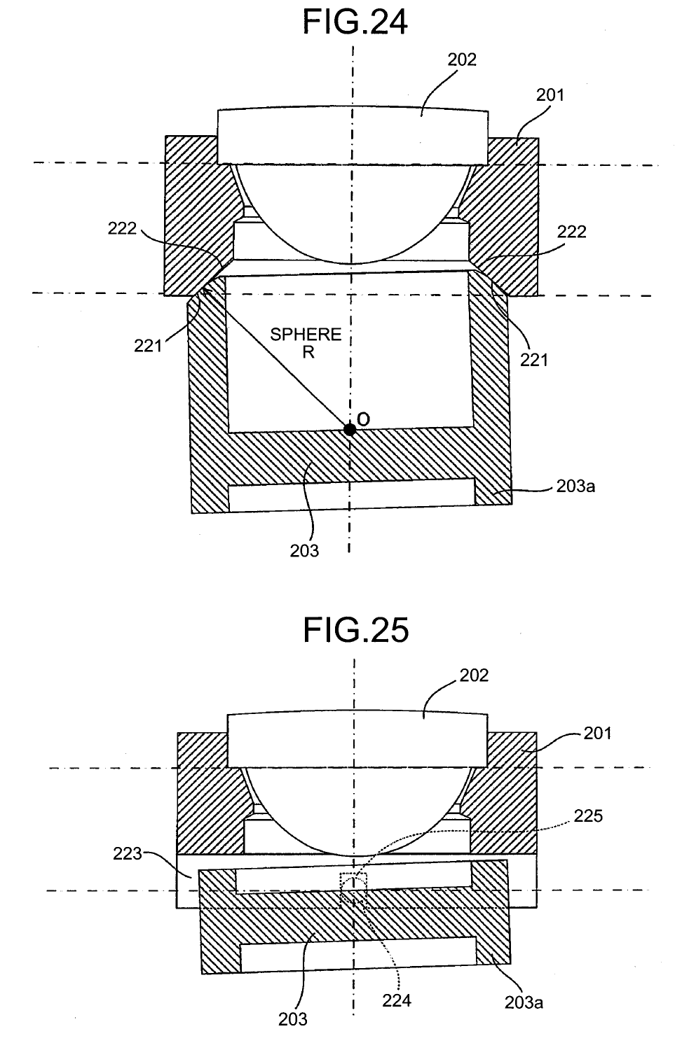

FIG. 25 is a partial sectional view of a lens holder of a lens actuator according to a sixteenth embodiment of the present invention. In the sixteenth embodiment, a groove 223 having the width same as a diameter of an external cylindrical surface of the flange section 203a is formed in the lens holder 201 symmetrically to the optical axis of the objective lens 202. The external cylindrical surface of the flange section 203a is fit in this groove 223.

A projection 224 having a columnar shape, which has the center axis on the axis passing through the center O of the surface on the objective lens 202 side of the diffractive optical element 203, is laterally provided on the external cylindrical surface of the flange section 203a. The projection 224 is fit in a rectangular groove 225 provided, in association with the projection 224, in a direction perpendicular to the groove 223 in a wall in which the groove 223 is formed.

With this structure, in the sixteenth embodiment, it is possible to perform positioning of optical axes in two directions in a plane perpendicular to the optical axis of the objective lens 202 and tilt the diffractive optical element 203 by rotating the element around the columnar projection 224.

Although a tilt regulating mechanism is not shown in FIG. 25, the lens holder 201 and the flange section 203a can be fixed after adjustment. Alternatively, projections can be provided in the tilted flange section 203a and brought into contact with the lens holder 201 to determine a tilt of the flange section 203a and fix the flange section 203a. Consequently, it is possible to accurately perform positioning and adjustment of a tilt of the diffractive optical element 203 with respect to the objective lens 202 without providing a structure tilted with respect to the optical axis of the objective lens 202.

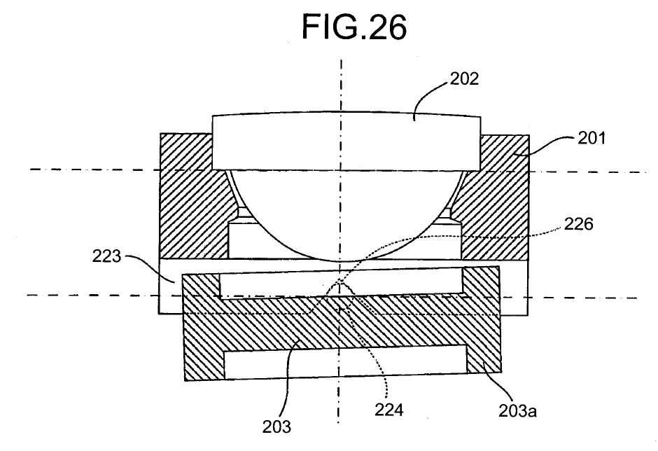

FIG. 26 is a partial sectional view of a lens holder of a lens actuator according to a seventeenth embodiment of the present invention, which is a modification of the sixteenth embodiment. The seventeenth embodiment is different from the sixteenth embodiment only in that the rectangular groove 225 in the sixteenth embodiment is changed to a V-shaped groove 226. Consequently, as in the sixteenth embodiment, it is possible to accurately perform positioning and adjustment of a tilt of the diffractive optical element 203 with respect to the objective lens 202 without providing a structure tilted with respect to the optical axis of the objective lens 202.

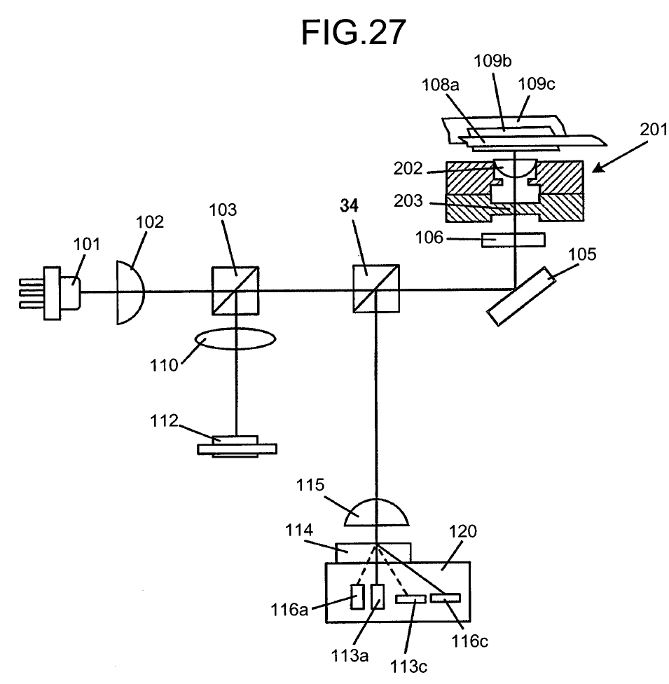

FIG. 27 is a schematic diagram of an optical pickup device mounted with the objective lens actuator according to the embodiments. The optical pickup device is a compatible optical pickup that records information in and reproduces information from three types of optical recording media (BD, DVD, and CD recording media) at the different numerical apertures (NAs) with the single objective lens 202 using the different light source wavelengths. The same description as previously given in connection with FIG. 5 is not repeated.

In an eighteenth embodiment of the present invention, an optical recording/reproducing apparatus includes the optical pickup equivalent to the optical pickup device shown in FIG. 27. The structure of the optical recording/reproducing apparatus mounted with the pickup is basically the same as previously described in connection with FIG. 5. Therefore, the same explanation is not repeated.

With the optical pickup according to the embodiments of the present invention, an optical recording/reproducing device can record information in and reproduce information from a plurality of types of optical recording media having different substrate thicknesses with high accuracy.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An objective lens actuator comprising:
a lens holder that holds an objective lens on a first-surface side;
a driving coil that is provided in the lens holder and generates focusing thrust and tracking thrust;
an elastic supporting member that elastically supports the lens holder according to an amount of thrust generated by the driving coil;
a diffractive optical element that is located on an incident side of the objective lens, outputs a laser beam, and is compatible with a reflection signal of the laser beam; and
an inertia ballast that is located on a second-surface side of the lens holder, wherein
the objective lens and the diffractive optical element are directly fixed to the lens holder.

2. The objective lens actuator according to claim 1, wherein the diffractive optical element is located on the second-surface side of the lens holder.

3. The objective lens actuator according to claim 1, wherein the diffractive optical element is made of resin.

4. The objective lens actuator according to claim 1, wherein the inertia ballast is made of a metal sheet.

5. The objective lens actuator according to claim 1, wherein the inertia ballast covers an entire second-surface of the lens holder except for an area corresponding to the diffractive optical element.

6. The objective lens actuator according to claim 1, wherein
the diffractive optical element supports compatibility among optical recording media of a plurality of standards corresponding to light sources of a plurality of different wavelengths, and
the diffractive optical element is set such that an optical axis of the diffractive optical element is tilted with respect to an optical axis of the objective lens.

7. The objective lens actuator according to claim 6, wherein,
any one of the lens holder and the diffractive optical element includes a projection having a hemispherical shape or a shape forming part of a sphere at three positions around the optical axis of the objective lens,
other one of the lens holder and the diffractive optical element includes a hemispherical recess corresponding to the projection, and
the projection and the recess position the diffractive optical element with respect to the optical axis of the objective lens.

8. The objective lens actuator according to claim 6, wherein,
any one of the lens holder and the diffractive optical element includes a projection having a hemispherical shape or a shape forming part of a sphere at three positions around the optical axis of the objective lens,
other one of the lens holder and the diffractive optical element includes a conical recess corresponding to the projection, and
the projection and the recess position the diffractive optical element with respect to the optical axis of the objective lens.

9. The objective lens actuator according to claim 6, wherein,
any one of the lens holder and the diffractive optical element includes a projection having a hemispherical shape or a shape forming part of a sphere at three positions around the optical axis of the objective lens,
other one of the lens holder and the diffractive optical element includes a cross-sectionally V-shaped recess in a direction perpendicular to the optical axis of the objective lens that corresponds to the projection, and
the projection and the recess position the diffractive optical element with respect to the optical axis of the objective lens.

10. The objective lens actuator according to claim 6, wherein
the lens holder includes a first contact portion,
the diffractive optical element includes a second contact portion in contact with the first contact portion,
the second contact portion includes a spherical projection with a center near a surface center on an objective lens side on the optical axis of the diffractive optical element,
the first contact portion includes a recess corresponding to the projection, and
the projection and the recess adjust a position of the diffractive optical element with respect to the optical axis of the objective lens.

11. The objective lens actuator according to claim 6, wherein
the lens holder includes a first contact portion,
the diffractive optical element includes a second contact portion in contact with the first contact portion,
the second contact portion includes a spherical projection with a center near a surface center on an objective lens side on the optical axis of the diffractive optical element,
the first contact portion includes a surface corresponding to the projection, and
the projection and the recess adjust a position of the diffractive optical element with respect to the optical axis of the objective lens.

12. The objective lens actuator according to claim 6, wherein
any one of the lens holder and the diffractive optical element includes a lateral columnar projection with a center axis near a surface center on an objective lens side on the optical axis of the diffractive optical element,
other one of the lens holder and the diffractive optical element includes a cross-sectionally rectangular groove in a direction intersecting the optical axis of the objective lens that corresponds to the projection, and
the projection and the groove position the diffractive optical element with respect to the optical axis of the objective lens.

13. The objective lens actuator according to claim 6, wherein
any one of the lens holder and the diffractive optical element includes a lateral columnar projection with a center axis near a surface center on an objective lens side on the optical axis of the diffractive optical element,
other one of the lens holder and the diffractive optical element includes a cross-sectionally V-shape groove in a direction intersecting the optical axis of the objective lens that corresponds to the projection, and
the projection and the groove position the diffractive optical element with respect to the optical axis of the objective lens.

14. A diffractive optical element that supports compatibility among optical recording media of at least three different standards corresponding to light sources of at least three different wavelengths, wherein
the diffractive optical element is concentrically diffractive, the diffractive optical element comprising:
a first surface and a second surface each include aberration-correction areas corresponding to the different wavelengths and the different standards, respectively; and
a first peripheral area on the first surface and a second peripheral area on the second surface, the first peripheral area and the second peripheral area being externally asymmetrical.

15. The diffractive optical element according to claim 14, wherein any one of the first peripheral area and the second peripheral area is stepped convexly from an outer periphery to an inner periphery.

16. The diffractive optical element according to claim 14, wherein any one of the first peripheral area and the second peripheral area is tapered from an outer periphery to an inner periphery.

17. The diffractive optical element according to claim 14, wherein the first peripheral area and the second peripheral area are in a shape such that an optical axis of aberration-correction areas is tilted at a predetermined angle with respect to an optical axis of an objective lens.

18. An objective lens actuator comprising the diffractive optical element according to claim 14.

19. An optical pickup device comprising the diffractive optical element according to claim 14.
